(19) United States
(12) Patent Application Publication
(10) Pub. No.: US 2026/0219620 A1
(43) Pub. Date: Jul. 30, 2026

(54) IMAGE FORMING APPARATUS

(71) Applicant: CANON KABUSHIKI KAISHA, Tokyo (JP)

(72) Inventors: KEISUKE ISHIZUMI, Kanagawa (JP); SHOHEI ISHIO, Tokyo (JP)

(21) Appl. No.: 19/573,893

(22) Filed: Mar. 20, 2026

Related U.S. Application Data
(63) Continuation of application No. PCT/JP2024/080130, filed on Aug. 2, 2024.

(30) Foreign Application Priority Data
Sep. 22, 2023 (JP) 2023-159284

(51) Int. Cl. G03G 15/00; G03G 15/01; G03G 21/00

(52) U.S. Cl. CPC G03G 15/5033; G03G 15/5012; G03G 15/5054; G03G 15/55; G03G 15/757; G03G 21/0005; G03G 15/0189; G03G 2215/00071

(57) ABSTRACT

An image forming apparatus has a constitution including a controller capable of carrying out control so as to execute deposition matter removal processing for removing a deposited matter on a surface of an image bearing member during execution of a print job on the basis of a detection signal output after receiving reflected light by a light receiving element in a period from passage, through the detecting position of an optical sensor, of a trailing end of an image forming region of the surface of the image bearing member, where a toner image to be transferred onto a preceding recording material is formable until a leading end of an image forming region of the surface of the image bearing member, where the toner image to be transferred onto a subsequent recording material is formable reaches the detecting position.

### TECHNICAL FIELD

The present invention relates to an image forming apparatus, such as a printer, a copying machine, a facsimile apparatus, or a multi-function machine provided with a plurality of functions of these, using an electrophotographic process or an electrostatic recording process.

### BACKGROUND ART

Conventionally, for example, in the image forming apparatus such as the printer using the electrophotographic process, an electrostatic latent image is formed on a photosensitive member, and toner which is a charged coloring material is supplied to this electrostatic latent image, so that a toner image is formed on the photosensitive member. This toner image is transferred onto a recording material such as paper directly or through an intermediary transfer member, and is fixed, whereby an image is formed on the recording material. As the photosensitive member, a photosensitive drum which is a drum-type photosensitive member is widely used. Further, as the intermediary transfer member, an intermediary transfer belt constituted by an endless belt is widely used.

Such an image forming apparatus has a function is some cases such that the image forming apparatus detects abnormality on the photosensitive drum or the intermediary transfer belt, which are image bearing members, and an occurrence of an image defect with the abnormality is suppressed. As the abnormality on the photosensitive drum or the intermediary transfer belt, for example, abnormality due to dew condensation or the like inside the image forming apparatus would be considered. In the case where the dew condensation are deposited on the photosensitive drum or the intermediary transfer belt, the following inconveniences occur in some cases. For example, an image with a thin density is printed with a fluctuation in surface potential of the photosensitive drum in some cases. Further, the water droplets collect toner deposited on a cleaning member for cleaning a surface of the photosensitive drum or a surface of the intermediary transfer belt or on a toner charging member, and an image defect due to transfer of the collected toner onto the recording material such as the paper occurs in some cases.

The image forming apparatus is installed in various air-conditioned environments, and an environment in a room is largely changed during an operation of an air-conditioning function in some cases. The image forming apparatus is substantially closed hermetically by an outer casing cover, and therefore, an inside temperature changes with a certain time difference relative to a change in environment in the room. For that reason, in the case where a warming function is operated in an environment in which the inside of the room is cold, the temperature of the inside of the image forming apparatus is still low compared with a temperature rise in the room. Then, for example, when a sheet (paper) discharge tray or a cartridge tray is opened or when a fan for air-cooling an IC chip such as a motor driver disposed inside the image forming apparatus is actuated, a warm air in the room enters the inside of the image forming apparatus, so that dew condensation occurs in some cases.

In Japanese Laid-Open Patent Application (JP-A) No. 2021-026192, a constitution in which in the case where a temperature/humidity sensor disposed inside the image forming apparatus detects a temperature/humidity in advance of image formation and dew condensation of the inside of the image forming apparatus is suspected from the detected temperature/humidity, an operation for discriminating whether or not the inside of the image forming apparatus is in a dew condensation state is performed is proposed. In the constitution described in JP-A No. 2021-026192, a toner patch for detecting the dew condensation state is formed and a density of this toner patch is detected by a density detecting means, and discrimination that the inside of the image forming apparatus is in the dew condensation state is made in the case where the density is thinner than a predetermined density and an operation in a dew condensation restoration mode is executed.

### SUMMARY OF THE INVENTION

### Problem to be Solved by the Invention

In the constitution of JP-A No. 2021-026192, by the temperature/humidity sensor disposed inside the image forming apparatus in advance of the image formation, a state which is suspected as the dew condensation state is detected. However, for example, in the case where air blown from the air-conditioning function directly flows in the inside of the image forming apparatus and dew condensation is generated by contact with a member low in temperature inside the image forming apparatus, there arises the following problem. For example, in the case where the air flows in the inside of the image forming apparatus through a sheet (paper) discharge opening of the image forming apparatus by blowing the air from a ceiling as by the fan during a print job, warm water vapor generated from the recording material such as the paper passed through a fixing device flows back into the inside of the image forming apparatus, and noticeable dew condensation is locally generated during the print job in some instances.

Further, in the constitution of JP-A No. 2021-026192, the temperature/humidity is detected by the temperature/humidity sensor in advance of the image formation, and in the case where the dew condensation state is suspected from the detected temperature/humidity, the toner patch is formed and discrimination as to whether or not the inside of the image forming apparatus is in the dew condensation state is made. As a result thereof, in the case where discrimination that the inside of the image forming apparatus is not in the dew condensation state was made, a normal image forming operation is to be performed. For that reason, useless toner consumption and down time by formation of the toner patch occur, so that there is a possibility that usability is impaired.

Therefore, an object of the present invention is to suppress an image defect generated by dew condensation or the like during a print job.

### Means for Solving the Problem

The above-described object is achieved by an image forming apparatus according to the present invention. In summary, the present invention is an image forming apparatus for executing a print job in which a print image is formed on a single or a plurality of recording materials by one start instruction and the single or the plurality of recording materials are discharged from an inside to an outside of the image forming apparatus through a recording material discharge opening, the image forming apparatus comprising: toner image forming means for forming a toner image; a rotatable image bearing member for bearing the toner image, on a surface thereof, formed by the toner image forming means; a transfer means for transferring the toner image, onto the recording material, formed on the surface of the image bearing member; and an optical sensor which includes a light emitting element for emitting light toward the surface of the image bearing member and a light receiving element for receiving reflected light reflected after emission of the light from the light emitting element toward the surface of the image bearing member and for outputting a detection signal depending on a light reception amount and which is for detecting the reflected light in a detecting position in a movement direction of the surface of the image bearing member, wherein the image forming apparatus comprises a controller capable of carrying out control so as to execute deposition matter removal processing for removing a deposited matter on the surface of the image bearing member during execution of the print job on the basis of the detection signal output after receiving the reflected light by the light receiving element in a period from passage, through the detecting position, of a trailing end of an image forming region of the surface of the image bearing member with respect to the movement direction, where the toner image to be transferred onto a preceding recording material is formable until a leading end of an image forming region of the surface of the image bearing member with respect to the movement direction, where the toner image to be transferred onto a subsequent recording material is formable reaches the detecting position.

According to another aspect of the present invention, there is provided an image forming apparatus for executing a print job in which a print image is formed on a single or a plurality of recording materials by one start instruction and the single or the plurality of recording materials are discharged from an inside to an outside of the image forming apparatus through a recording material discharge opening, the image forming apparatus comprising: toner image forming means for forming a toner image; a rotatable image bearing member for bearing the toner image, on a surface thereof, formed by the toner image forming means; a driving portion for rotationally driving the image bearing member; a transfer means for transferring the toner image, onto the recording material, formed on the surface of the image bearing member; and an optical sensor which includes a light emitting element for emitting light toward the surface of the image bearing member and a light receiving element for receiving reflected light reflected after emission of the light from the light emitting element toward the surface of the image bearing member and for outputting a detection signal depending on a light reception amount and which is for detecting the reflected light in a detecting position in a movement direction of the surface of the image bearing member, wherein the image forming apparatus comprises a controller capable of carrying out control of the driving portion during execution of the print job so that a time from passage, through the detecting position, of a trailing end of an image forming region of the surface of the image bearing member with respect to the movement direction, where the toner image to be transferred onto a final recording material in the print job is formable until rotation of the image bearing member is stopped in a case where a numerical value related to a detection signal output after receiving the reflected light by the light receiving element after the passage, through the detecting position, of the trailing end of the image forming region of the surface of the image bearing member with respect to the movement direction, where the toner image to be transferred onto the final recording material is formable satisfies a predetermined condition is made longer than that in a case where the numerical value related to the detection signal does not satisfy the predetermined condition.

### Effect of the Invention

According to the present invention, it becomes possible to suppress the image defect generated by the dew condensation or the like during the print job.

### BRIEF DESCRIPTION OF THE DRAWINGS

FIG. 1 is a schematic sectional view of an image forming apparatus.

FIG. 2 is a block diagram showing a control constitution of the image forming apparatus.

FIG. 3 is a top plan view for illustrating an arrangement of an optical sensor.

FIG. 4 is a schematic sectional view for illustrating a constitution of the optical sensor.

FIG. 5 is a graph showing a detection waveform in the case where reflected light from an intermediary transfer belt is detected by the optical sensor.

FIG. 6 is a graph showing a detection waveform in the case where reflected light from a toner patch is detected by the optical sensor.

FIG. 7 is a timing chart showing an outline of an example of an operation in the print job.

FIG. 8 is a graph showing a detection waveform in the case where reflected light from the intermediary transfer belt is detected by the optical sensor in a state in which water droplets are deposited on a surface of the intermediary transfer belt by dew condensation.

FIG. 9 is a schematic view showing an example of a condition in which the dew condensation occurs inside the image forming apparatus.

FIG. 10 is a graph for illustrating a change in surface potential of the photosensitive drum due to presence/absence of the dew condensation.

FIG. 11 is a timing chart showing an outline of an example of an operation during a blank rotation operation.

FIG. 12 is a flowchart showing an example of an operation of the print job.

FIG. 13 is a flowchart showing another example of the operation of the print job.

FIG. 14 is a timing chart showing an outline of another example of the operation during the print job.

FIG. 15 is a timing chart showing an outline of another example of the operation during the print job.

FIG. 16 is a schematic sectional view of another example of the image forming apparatus.

FIG. 17 is a timing chart showing another example of the operation during the blank rotation operation.

FIG. 18 is a flowchart showing another example of the operation of the print job.

FIG. 19 is a graph showing a detection waveform in the case where diffused reflection light from sand on the intermediary transfer belt is detected by the optical sensor.

FIG. 20 is a graph showing a detection waveform in the case where specularly reflected light from sand on the intermediary transfer belt is detected by the optical sensor.

FIG. 21 is a flowchart showing another example of the operation of the print job.

FIG. 22 is a flowchart showing another example of the operation of the print job.

### EMBODIMENTS FOR CARRYING OUT THE INVENTION

In the following, an image forming apparatus according to the present invention will be further described specifically based on the drawings. However, dimensions, materials, shapes, relative arrangement, and the like of constituent elements described in this embodiment should be appropriately changed by constitutions and various conditions of apparatus (devices) to which the present invention is applied, and is not intended to limit the scope of the present invention to the following embodiments.

### Embodiment 1

### 1. Overall Configuration and Operation of Image Forming Apparatus

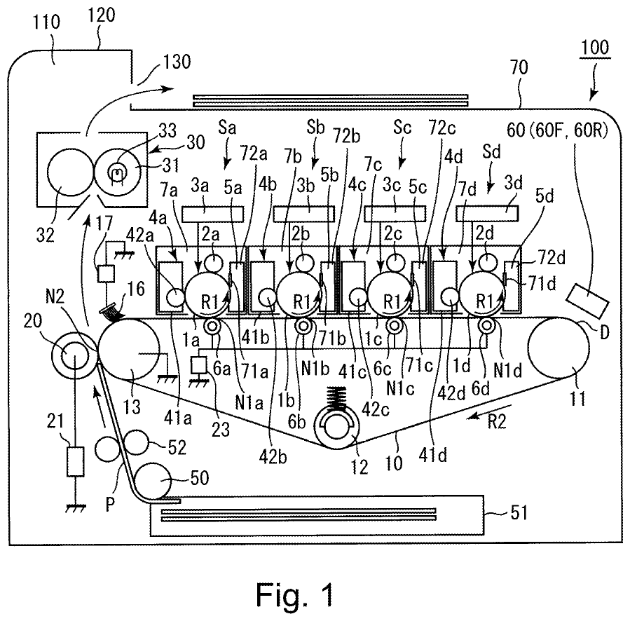

FIG. 1 is a schematic sectional view of an image forming apparatus 100 of this embodiment. The image forming apparatus 100 of this embodiment is a tandem type laser beam printer which is capable of forming a full-color image on a sheet-like recording material P by using an electrophotographic process and which employed an intermediary transfer type. The image forming apparatus 100 forms an image on the recording material P on the basis of a signal (information) input from an external device, for example, a host computer such as an image reading apparatus or a personal computer, connected to the image forming apparatus 100.

The image forming apparatus 100 includes four image forming portions Sa, Sb, Sc, and Sd as a plurality of image forming portions (stations) inside a casing (outer casing cover) 120 of an apparatus main assembly 110. The image forming portions Sa, Sb, Sc, and Sd from images by toner of colors of yellow (Y), magenta (M), cyan (C), and black (K), respectively. These four image forming portions Sa, Sb, Sc, and Sd are arranged in a line in a direction (substantially horizontal direction in this embodiment) crossing a vertical direction with a certain interval.

Incidentally, a constitution of each image forming portion S is substantially the same except for the color of the toner used. As regards elements having the same or corresponding functions or constitutions provided for the respective colors, suffixes a, b, c, and d of symbols (reference numerals) each showing an element for either one of the colors are omitted and will be collectively described in some instances. Further, for convenience, large/small (high/low) of a voltage or a potential (or potential difference) refers to large/small (high/low) in the case where values thereof are compared in terms of absolute values unless otherwise specifically mentioned. Further, in the image forming apparatus 100, as the recording material P, paper is principally used, and therefore, the recording material P is referred to as the paper in some instances, but the recording material P includes a material other than the paper or one formed of a material containing the material other than the paper.

In this embodiment, the image forming portion S is constituted by including a photosensitive drum 1 (1a, 1b, 1c, 1d), a charging roller 2 (2a, 2b, 2c, 2d), a developing device (4a, 4b, 4c, 4d), a drum cleaning device (5a, 5b, 5c, 5d), and the like which are described later.

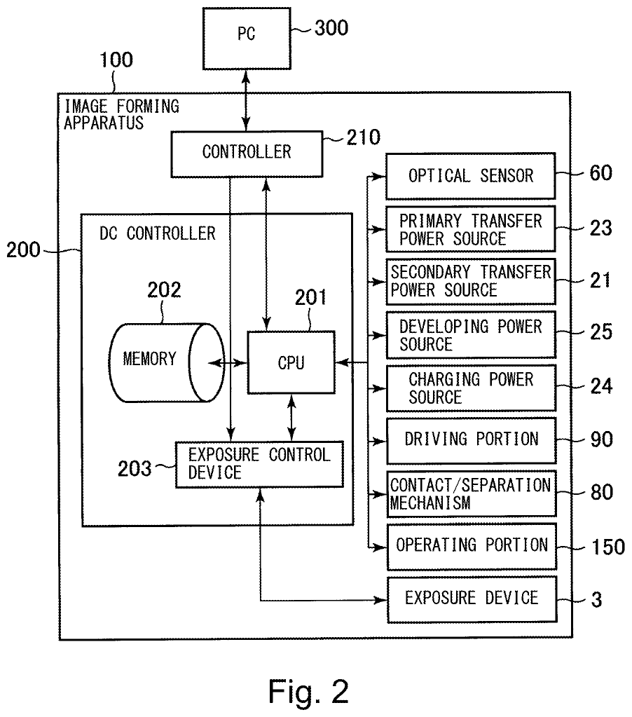

The photosensitive drum 1 which is a rotatable drum-type (cylindrical) photosensitive member (electrophotographic photosensitive member) as a first image bearing member for bearing a toner image is rotationally driven in an arrow R1 direction (counterclockwise direction) in FIG. 1 at a predetermined peripheral speed (process speed) by a driving force transmitted from a driving motor provided to a driving portion 90 (FIG. 2) as a driving means. In this embodiment, the photosensitive drum 1 is rotationally driven at a peripheral speed of 200 mm/sc. When a print job is started by receiving an image signal by a DC controller 200 as a controller (control portion) described later, rotational drive of the photosensitive drum 1 is started.

A surface of the rotating photosensitive drum 1 is electrically charge-processed uniformly to a predetermined polarity (negative polarity in this embodiment) and a predetermined potential (dark portion potential Vd) by the charging roller 2 which is a roller-type charging member as a charging means. The charging roller 2 is disposed in contact with the surface of the photosensitive drum and is pressed toward the photosensitive drum 1 by a predetermined pressing force. The charging roller 2 is rotated with rotation of the photosensitive drum 1. During the charging, to the charging roller 2, a charging voltage (charging bias) which is a DC voltage of the same polarity (negative polarity in this embodiment) as charge polarity of the photosensitive drum 1 is applied by a charging power source (high-voltage power source) 24 (FIG. 2) as a charging voltage applying means (charging voltage applying portion).

The charged surface of the rotating photosensitive drum 1 is subjected to scanning exposure to light depending on the image signal by an exposure device (laser scanner unit) 3 as an exposure means, so that an electrostatic latent image (latent image) of a color component corresponding to each of the image forming portions S is formed on the photosensitive drum 1. For example, during full-color image formation, the photosensitive drums 1a, 1b, 1c, and 1d are exposed to light depending on image signals of color components corresponding to the image forming portions by the exposure devices 3a, 3b, 3c, and 3d, respectively. By this, on the photosensitive drums 1a, 1b, 1c, and 1d, electrostatic latent images corresponding to color component images of yellow, magenta, cyan, and black for objective color images are formed, respectively.

The electrostatic latent image formed on the photosensitive drum 1 is developed (visualized) by being supplied with toner as a developer by the developing device (developing unit) 4 as a developing means, so that a toner image (toner picture, developer image) is formed on the photosensitive drum 1. The developing device 4 includes a developing container 41 for accommodating the toner which is a non-magnetic one-component developer as the developer and includes a developing roller 42 as a developing member (developer carrying member). During the development, the developing roller 42 is contacted to the surface of the photosensitive drum 1. Further, during the development, the developing roller 42 is rotationally driven by a driving force transmitted from the driving motor provided to the driving portion 90 (FIG. 2) as the driving means. In this embodiment, the developing roller 42 is rotationally driven at a peripheral speed of 300 mm/sec in a rotational direction in which a surface of the developing roller 42 moves in the same direction as the surface of the photosensitive drum 1 in a contact portion between the photosensitive drum 1 and the developing roller 42. Thus, by rotating the developing roller 42 at a speed which is 1.5 times the speed of the photosensitive drum 1, the development can be stably performed. The developing roller 42 carries the toner accommodated in the developing container 41, and conveys the toner to a developing position which is the contact portion between the photosensitive drum 1 and the developing roller 42. Further, during the development, to the developing roller 42, a developing voltage (developing bias) which is a DC voltage of the same polarity (negative polarity in this embodiment) as the charge polarity of the photosensitive drum 1 is applied by a developing power source (high-voltage power source) 25 (FIG. 2) as a developing voltage applying means (developing voltage applying portion). In this embodiment, a normal charge polarity of the toner carried on the developing roller 42 is the negative polarity. Further, in this embodiment, the developing device 4 deposits the toner, charged to the same polarity (negative polarity in this embodiment) as the charge polarity of the photosensitive drum 1 by the charging roller 2, on a portion (image portion) where a potential is lowered by the exposure on the photosensitive drum 1 (reversal development system). However, the present invention can also be applied to an image forming apparatus in which the development is performed by the toner charged to the opposite polarity to the charge polarity of the photosensitive drum 1.

In this embodiment, the image forming apparatus 100 includes a contact/separation mechanism 80 (FIG. 2) for bringing the developing roller 42 into contact with the photosensitive drum 1 and for separating the developing roller 42 from the photosensitive drum 1. In this embodiment, during stop of the image forming apparatus 100 or the like, the developing roller 42 is separated from the photosensitive drum 1 by the contact/separation mechanism 80. Further, during the development, the developing roller 42 is contacted to the photosensitive drum 1 by the contact/separation mechanism 80. In this embodiment, the developing container 41 is swingably constituted and is urged in a direction, in which the developing roller 42 is contacted to the photosensitive drum 1, by a pressing spring which is an urging member as an urging means. The contact/separation mechanism 80 moves (rotates) the developing container 41 against an urging force of the above-described pressing spring, so that the developing roller 42 can be separated from the photosensitive drum 1. Further, the contact/separation mechanism 80 permits movement (rotation) of the developing container 41 by the urging force of the above-described pressing spring, so that the developing roller 42 can be contacted to the photosensitive drum 1. The contact/separation mechanism 80 is driven by a driving force transmitted from the driving motor provided to the driving portion 90 (FIG. 2) as the driving means. Further, the developing roller 42 is rotationally driven when contacted to the photosensitive drum 1, and rotation thereof is stopped when separated from the photosensitive drum 1.

Incidentally, in this embodiment, a rotational speed of the developing roller 42 is set so that a solid density (maximum image density) for each of yellow, magenta, cyan, and black becomes 1.5 for A4-size paper of “GF-C081” which is paper manufactured by Canon Kabushiki Kaisha. The solid density was measured by a handy densitometer “exact” of X-rite Inc.

Further, in this embodiment, during the charging, to the charging roller 2, a charging voltage of −1000 V is applied, so that the surface of the photosensitive drum 1 is charged uniformly to a surface potential (dark portion potential Vd) of −600 V. Further, in this embodiment, an exposure amount (laser light quantity: μJ/cm²) is set so that a surface potential (light portion potential VL) of the photosensitive drum 1 after exposed by the exposure device 3 becomes-200 V. Further, in this embodiment, during the development, to the developing roller 42, a developing voltage of −350 V is applied.

In this embodiment, a toner image forming means for forming the toner image is constituted by the charging roller 2, the exposure device 3, the developing device 4, and the like.

Opposed to the four photosensitive drums 1, as a second image bearing member for bearing the toner image, an intermediary transfer belt 10 which is an intermediary transfer member constituted by a rotatable endless belt is disposed. The intermediary transfer belt 10 is stretched by three shafts of first, second, and third stretching rollers 11, 12, 13 as a plurality of stretching rollers. The first stretching roller 11 forms a surface of the intermediary transfer belt 10, onto which the toner image is transferred, in cooperation with the third stretching roller 13. The second stretching roller 12 functions as a tension roller for imparting a predetermined tension to the intermediary transfer belt 10. The third stretching roller 13 functions as a driving roller for transmitting a driving force to the intermediary transfer belt 10, and in addition, functions as an opposing roller to a secondary transfer roller 20 described later. To the intermediary transfer belt 10, tension of 60 N is imparted by the second stretching roller 12. Further, the intermediary transfer belt 10 is rotated (moved circumferentially, moved in a circulatory manner) in an arrow R2 direction (clockwise direction) in FIG. 1 by rotationally driving the third stretching roller 13 by the driving force transmitted from the driving motor provided to the driving portion 90 (FIG. 2) as the driving means. The intermediary transfer belt 10 is rotationally driven at a peripheral speed (about 200 mm/sec) corresponding to the peripheral speed of the photosensitive drum 1. The first and second stretching rollers 11 and 12 are rotated with rotation of the intermediary transfer belt 10. On an inner peripheral surface side of the intermediary transfer belt 10, corresponding to the photosensitive drums 1a, 1b, 1c, and 1d, primary transfer rollers 6a, 6b, 6c, and 6d which are roller-type primary transfer members as primary transfer means are disposed, respectively. The primary transfer roller 6 contacts an inner peripheral surface of the intermediary transfer belt 10 and presses the intermediary transfer belt 10 toward the photosensitive drum 1, so that a primary transfer portion (primary transfer nip) N1 which is a contact portion between the photosensitive drum 1 and the intermediary transfer belt 10 is formed. The primary transfer roller 6 is rotated with rotation of the intermediary transfer belt 10.

The toner image formed on the photosensitive drum 1 is transferred (primarily transferred) onto the rotating intermediary transfer belt 10 as a transfer-receiving member by the action of the primary transfer roller 6 in the primary transfer nip N1. During the primary transfer, to the primary transfer roller 6, a primary transfer voltage (primary transfer bias) which is a DC voltage of an opposite polarity (positive polarity in this embodiment) to the normal charge polarity of the toner is applied by a primary transfer power source (high voltage power source) 23 as a primary transfer voltage applying means (primary transfer voltage applying portion). In this embodiment, during the primary transfer, to the primary transfer roller 6, a primary transfer voltage of +500 V is applied. For example, at the time of formation of a full-color image, toner images of colors of yellow, magenta, cyan, and black formed on the four photosensitive drums 1a, 1b, 1c, and 1d are successively transferred onto the intermediary transfer belt 10 in a superposition manner. By this, a four-color toner image corresponding to an objective color image is formed on the intermediary transfer belt 10. In this embodiment, the primary transfer power source 23 is common power source capable of applying a voltage of the positive polarity or the negative polarity. The primary transfer power source 23 is capable of outputting the voltage of the positive polarity in a range of +100 V~+2000 V (with respect to a numerical value range, “~” shows a range including numerical values before and after “~”), and is capable of outputting the voltage of the negative polarity in a range of −200 V~−2000 V. In this embodiment, a constitution in which the voltage is applied from the primary transfer power source 23 common to the plurality of primary transfer rollers 6 will be described, but the present invention is not limited thereto. Even in a constitution in which a plurality of primary transfer power sources are provided correspondingly to the respective primary transfer rollers 6, the present invention is applicable.

Here, in this embodiment, the intermediary transfer belt 10 is constituted by an endless belt (film) consisting of two layers including a base layer and a surface layer. The base layer is a 70 μm-thick layer formed of a material prepared by dispersing a quaternary ammonium salt, which is an ion conductive agent as an electric resistance adjusting agent, in polyethylene naphthalate resin, and is 2000 MPa in elastic modulus. In this embodiment, the base layer of the intermediary transfer belt 10 is formed by blow molding, but as a molding method, in addition to the blow molding, there are centrifugal molding, tube molding, inflation molding, extrusion molding, cylindrical extrusion molding, and the like. The surface layer is formed on an outer peripheral surface of the base layer on an outer peripheral surface side of the intermediary transfer belt 10. The surface layer is a 3 μm-thick layer formed of a material prepared by dispersing antimony-doped zinc oxide as an electric resistance adjusting agent in acrylic resin as a base material and by adding polytetrafluoroethylene (PTFE) particles as a solid lubricant to a resultant dispersion. As a surface layer forming method, for example, there are dip coating, spray coating, flow coating, shower coating, roll coating, spin coating, ring coating, and the like. For the intermediary transfer belt 10 in this embodiment, the base layer obtained by blow molding is fitted to an outer periphery of a cylindrical mold, and end portions thereof are sealed, and then the base layer is dipped together with the mold into a container filled with a surface layer liquid and is pulled up so that a relative speed between a liquid surface of a curable composition and the base layer becomes constant, whereby a coating film comprising the surface layer liquid was formed on the base layer surface.

In this embodiment, volume resistivity of the intermediary transfer belt 10 is 1×10¹⁰ Ω·cm. The volume resistivity of the intermediary transfer belt 10 was measured by connecting a UR probe (Model: MCP-12) to Hiresta-UP (MCP-HT450) of Mitsubishi Chemical Corporation and then by being measured at an applied voltage of 100 V and a measurement time of 10 sec. An environment of a measurement chamber in which the volume resistivity of the intermediary transfer belt 10 is measured is set to 23° C. in temperature and 50% RH in humidity (relative humidity), and the volume resistivity of the intermediary transfer belt 10 after the intermediary transfer belt 10 was left standing in the measurement chamber for 4 hours was measured. Further, in this embodiment, glossiness of the surface (outer peripheral surface) of the intermediary transfer belt 10 is 75. The glossiness of the surface of the intermediary transfer belt 10 was measured by a handy glossmeter IG-320 of HORIBA, Ltd. Further, in this embodiment, a peripheral length of the intermediary transfer belt 10 is 800 mm.

Further, in this embodiment, the primary transfer roller 6 is a roller, of 11 mm in outer diameter, prepared by covering a foam sponge member which is adjusted to have volume resistivity of 10⁵ Ω·cm and a thickness of 3 mm and which contains NBR and epichlorohydrin as a main component, around nickel-plated steel rod of 5 mm in outer diameter. Incidentally, in this embodiment, rubber hardness of the foam sponge member constituting the primary transfer roller 6 was hardness of 20° to 500 g load in the case where the rubber hardness was measured by using an Asker hardness meter C type.

On an outer peripheral surface side of the intermediary transfer belt 10, in a position opposing the third stretching roller 13, a secondary transfer roller 20 which is a roller-type secondary transfer member as a secondary transfer means is disposed. The secondary transfer roller 20 contacts the outer peripheral surface of the intermediary transfer belt 10 and is pressed by a pressing force of 50 N to the third stretching roller 13 disposed in a position opposing the secondary transfer roller 20 through the intermediary transfer belt 10. By this, the secondary transfer roller 20 forms a secondary transfer portion (secondary transfer nip) N2 which is a contact portion between the intermediary transfer belt and the secondary transfer roller 20. The secondary transfer roller 20 is rotated with the rotation of the intermediary transfer belt 10. The toner images formed on the intermediary transfer belt 10 are transferred (secondarily transferred) onto the recording material P as the transfer-receiving member nipped and conveyed by the intermediary transfer belt 10 and the secondary transfer roller 20. During the secondary transfer, to the secondary transfer roller 20, a secondary transfer voltage (secondary transfer bias) which is a DC voltage of the opposite polarity (positive polarity in this embodiment) to the normal charge polarity of the toner is applied by a secondary transfer power source 21 as a secondary transfer voltage applying means (secondary transfer voltage applying portion). The voltage is applied from the secondary transfer power source (high voltage power source) 21, whereby a current flows from the secondary transfer roller 20 toward the third stretching roller 13. By this, the toner images carried on the intermediary transfer belt 10 are secondarily transferred onto the recording material P in the secondary transfer portion N2. Incidentally, during the secondary transfer, the voltage applied from the secondary transfer power source 21 to the secondary transfer roller 20 is controlled so that the current flowing from the secondary transfer roller 20 toward the third stretching roller 13 through the intermediary transfer belt 10 becomes constant. Further, a magnitude of the current for performing the secondary transfer is determined in advance depending on an installation environment (ambient environment) of the image forming apparatus 100 and a kind of the recording material P. In this embodiment, the secondary transfer power source 21 is capable of outputting a voltage in a range of +100 V~+4000 V. The third stretching roller 13 is electrically grounded (connected to a ground potential). The recording material (transfer materials, recording medium, media) P such as paper or an OHP sheet is accommodated in a cassette 51. This recording material P is fed from the cassette 51 by a feeding roller 50 or the like as a feeding member and is conveyed toward the secondary transfer portion N2 by being timed to the toner images on the intermediary transfer belt 10 by a registration roller pair 52 as a conveying member.

Further, in this embodiment, the secondary transfer roller 20 is a roller, of 18 mm in outer diameter, prepared by covering a foam sponge member which is adjusted to have volume resistivity of 10⁸ Ω·cm and a thickness of 5 mm and which contains NBR and epichlorohydrin as a main component, around nickel-plated steel rod of 5 mm in outer diameter. Incidentally, in this embodiment, rubber hardness of the foam sponge member constituting the secondary transfer roller 20 was hardness of 30° to 500 g load in the case where the rubber hardness was measured by using the Asker hardness meter C type. The recording material P on which the toner images are transferred is conveyed to a fixing device 30 as a fixing means. The fixing device 30 includes a fixing roller 31 incorporating therein a heater 33 as a heat source and a pressing roller 32 press-contacted to the fixing roller 31. The fixing device 30 heats and presses the recording material P carrying thereon unfixed toner images in a fixing portion (fixing nip) which is a contact portion between the fixing roller 31 and the pressing roller 32, so that the toner images are fixed (melted, stuck) on the recording material P. For example, during the formation of the full-color image, the four color toner images are melted and color-mixed and are fixed on the recording material P. The recording material P on which the toner images are fixed and a print image is formed is discharged (output) toward an outside (outside of the apparatus) of a casing 120 of the apparatus main assembly 110 through a sheet (paper) discharge opening (recording material discharge opening) 130 as an opening portion formed in the casing 120 of the apparatus main assembly 110. This recording material P is stacked on a tray 70 provided at an upper portion of the casing 120 of the apparatus main assembly 110.

On the other hand, toner (primary transfer residual toner) remaining on the surface of the photosensitive drum 1 after the primary transfer is removed and collected from the surface of the photosensitive drum 1 by the drum cleaning device 5 as a photosensitive member cleaning means. The drum cleaning device includes a cleaning blade 71 as a cleaning member disposed in contact with the surface of the photosensitive drum 1 and a cleaning container 72 for accommodating the primary transfer residual toner removed from the surface of the photosensitive drum 1 by the cleaning blade 71. The drum cleaning device 5 scrapes off the primary transfer residual toner from the surface of the rotating photosensitive drum 1 with the cleaning blade 71, and accommodates the toner in the cleaning container 72.

Further, toner (secondary transfer residual toner) remaining on the surface of the intermediary transfer belt 10 after the secondary transfer is charged to the opposite polarity (positive polarity in this embodiment) to the normal charge polarity of the toner by an electroconductive brush 16 as a toner charging member. Then, this toner is moved to the photosensitive drum 1 in the primary transfer portion N1, for example, a most upstream primary transfer portion N1a in a rotational direction (surface movement direction) of the intermediary transfer belt 10, and is collected by the drum cleaning device 5. During the cleaning of the intermediary transfer belt 10, to the electroconductive brush 16, an electroconductive brush voltage (electroconductive brush bias) which is a DC voltage of the opposite polarity (positive polarity in this embodiment) to the normal charge polarity of the toner is applied by an electroconductive brush power source (high voltage power source) 17 as a cleaning voltage applying means (cleaning voltage applying portion). Thus, in this embodiment, a deposited matter such as the secondary transfer residual toner or the like remaining on the intermediary transfer belt 10 after the secondary transfer is removed from the intermediary transfer belt 10 by using the electroconductive brush 16. In this embodiment, the electroconductive brush 16 is constituted by electroconductive pile yarn comprising, as a main component, electroconductive nylon, which has a density of 200 F/mm², a pile length of 5 mm, three pile rows, and a raw yarn resistance of 10¹⁰Ω. The electroconductive brush 16 contacts the outer peripheral surface of the intermediary transfer belt 10. The electroconductive brush 16 is disposed in a position on a side downstream of the secondary transfer portion N2 and on a side upstream of the primary transfer portion N1 (mostupstream primary transfer portion N1a) in the rotational direction of the intermediary transfer belt 10. In this embodiment, the electroconductive brush 16 is pressed to the third stretching roller 13, disposed in a position opposing the electroconductive brush 16 through the intermediary transfer belt 10, so that the electroconductive yarn enters the intermediary transfer belt 10 by 1 mm or more. Further, in this embodiment, the electroconductive brush power source 17 is capable of outputting a voltage in a range of +100 V~+4000 V.

The image forming apparatus 100 of this embodiment is capable of forming a full-color print image by the above-described operation. Further, the image forming apparatus 100 of this embodiment is also capable of forming a single color print image by using only desired one image forming portion S or a multi-color print image by using only some image forming portions S of the plurality of image forming portions S.

Further, in this embodiment, in each image forming portion S, the photosensitive drum 1 and as process means actable on the photosensitive drum 1, the charging roller 2, the developing device 4, and the drum cleaning device 5 are integrally assembled and constitute a process cartridge 7 (7a, 7b, 7c, 7d). The process cartridge 7 is detachably mountable to the apparatus main assembly 110 of the image forming apparatus 100 through a mounting means such as a mounting guide or a positioning member, provided in the apparatus main assembly 110 of the image forming apparatus 100. Incidentally, in this embodiment, the apparatus main assembly 110 is a portion such that the respective process cartridges 7 are excluded from the image forming apparatus 100.

Further, in the image forming apparatus 100, an optical sensor 60 used when correction control for correcting color misregistration or a density of the image formed in the image forming apparatus 100 is performed and further when a dew condensation state is detected is provided. The optical sensor 60 is disposed so as to detect the surface (outer peripheral surface) of the intermediary transfer belt 10 and the toner thereon in a position (detecting position) D on a side downstream of the primary transfer portion N1 (most downstream primary transfer portion N1d) and on a side upstream of the secondary transfer portion N2 in the rotational direction of the intermediary transfer belt 10. In this embodiment, the optical sensor 60 is disposed in a position opposing the first stretching roller 11 through the intermediary transfer belt 10. As regards the optical sensor 60, description will be made specifically later.

Incidentally, in the case where continuous printing for continuously forming print images on a plurality of recording materials P is executed, the above-described operation is repetitively performed. The image forming apparatus 100 of this embodiment executes the continuous printing with an interval (sheet interval) of 50 mm between a trailing end of a preceding sheet and a leading end of a subsequent (next) sheet, for example, in the case where the print images are formed on a plurality of A4 sheets.

### 2. Control Constitution

Next, control constitution of the image forming apparatus 100 in this embodiment will be described. FIG. 2 is a block diagram showing an outline of the control constitution for controlling the operation of the image forming apparatus 100 in this embodiment.

An external device 300 provides a print instruction (a start instruction or various pieces of setting information) to a controller 210 which is a converting portion as a converting means provided inside the image forming apparatus 100, and transmits image data of a print image to the controller 210. In this embodiment, the external device 300 is the personal computer (PC) which is the host computer. The controller 210 receives image data of RGB or CMYK from the external device 300 and converts the image data into exposure data (image signal) of CMYK in accordance with a mode designated from the external device 300. In this embodiment, the exposure data converted at this time is 600 dpi. In the mode designated from the external device 300, in addition to a kind and a size of paper, there is a mode related to an image quality, and there is also a mode in which a line number of a dither matrix is changed.

The controller 210 transfers the converted exposure data to an exposure control device 203 as an exposure control means provided in a DC controller 200 which is a control portion as a control means provided inside the image forming apparatus 100. The exposure control device 203 carries out control of the exposure device 3 by an instruction from a CPU 201 described later. In the image forming apparatus 100 of this embodiment, a half-tone density is controlled by adjustment of an ON/OFF area of the exposure data. When the CPU 201 receives the print instruction from the controller 210, the CPU 201 starts a print job.

In the DC controller 200, the CPU (arithmetic processor) 201 as an arithmetic processing means, a memory (storage portion) 202 constituted by including a ROM, a RAM, or the like as a storage means, and the like are equipped. The DC controller 200 controls operations of respective portions of the image forming apparatus 100 by executing processing in accordance with programs and data stored in the memory 202 in advance, in the CPU 201. The DC controller 200 (CPU 201) controls, for example, the charging power source 24, the developing power source 25, the exposure power source 203 (exposure device 3), the primary transfer power source 23, the secondary transfer power source 21, the driving portion 90, the contact/separation mechanism 80, and the like, and carries out image formation for executing formation of the electrostatic latent image, transfer of the toner image obtained by developing the electrostatic latent image, and the like. Further, the DC controller 200 (CPU 201), an operating portion 150 provided to the image forming apparatus 100 is connected. The operating portion 150 is constituted by including a display portion for displaying information by being controlled by the DC controller 200 (CPU 201), an input portion for inputting information to the DC controller 200 (CPU 201) on the basis of an operation by an operator such as a user or a service person, and the like. The operating portion 150 may also be constituted by including a touch panel also having functions of a display means and an input means.

Further, the DC controller 200 performs processing for receiving a signal from the optical sensor 60 used when the correction control for correcting the color misregistration or the density of the image formed in the image forming apparatus 100 is performed and further when the dew condensation state is detected. For example, in the above-described correction control, an amount of reflected light from a test pattern (toner image for detection) formed on the outer peripheral surface of the intermediary transfer belt 10 in a position opposing the optical sensor 60 is detected by the optical sensor 60. An output of a detection signal indicating a detection result of the amount of the reflected light by the optical sensor 60 is 0 V~3.3 V. In this embodiment, the optical sensor 60 is constituted so that the output of the detection signal becomes larger with a larger received light quantity of each of first and second light receiving elements 62 and 63 described later. The DC controller 200 (CPU 201) performs calculation by using the detection result by the optical sensor 60 and makes density correction and color misregistration correction. In this embodiment, as a method of density correction control, on the basis of a detection result of a test pattern for density detection (density control correction pattern), a correction curve of an image signal is generated such that a desired density curve can be obtained. Further, in this embodiment, as a method of color misregistration correction control, on the basis of a detection result of a test pattern for color misregistration amount detection (registration correction pattern), an image forming timing for each color is corrected. The color misregistration correction control and the density correction control are executed in the case where an execution condition depending on a change in predetermined temperature/humidity, a number of prints (number of supplied sheets), and the like is set in advance and the execution condition is satisfied. The detection of the dew condensation state will be described later specifically.

Incidentally, in this embodiment, the primary transfer power source 23 is made common to the four image forming portions S as described above. Further, in this embodiment, although illustration is omitted, the charging power source 24, the developing power source 25, and the contact/separation mechanism 80 are independently provided for each of the image forming portions S. Each of the charging power source 24, the developing power source 25, and the contact/separation mechanism 80 may also be made common to at least a part of the image forming portions S. Further, the driving portion 90 is constituted by including the driving motor as the driving source and a drive transmission member. The driving portion 90 includes the driving motor for driving the photosensitive drum 1, the member such as the developing roller 42 of the developing device 4, the intermediary transfer belt 10 (third stretching roller 13), the contact/separation mechanism 80, and the like. The driving motor for driving these members may be provided independently for each of these members, and the driving motor for driving at least a part of these members may be commonized. Further, the driving motor for driving the members for each color may be independently provided for each color, and the driving motor for driving the members for at least a part of the colors may be commonized. In this embodiment, in each of the image forming portions S, the photosensitive drum 1 and the developing roller 42 of the developing device 4 are constituted so as to be capable of being rotated and rotation-stopped independently of each other.

Here, the print job (print operation, print sequence, image forming operation, image forming sequence) is a series of operations which are started by a single start instruction and in which an image or images are formed and output on a single recording material P or a plurality of recording materials P, respectively. The print job includes, in general, an image forming step, a pre-rotation step, a sheet (paper) interval step in the case where the images are formed on the plurality of recording materials P, and a post-rotation step. The image forming step is a period in which formation of an electrostatic latent image of an image actually formed and output on the recording material P, formation of a toner image, and primary transfer, secondary transfer, and fixing of the toner image are performed, and during image formation refers to this period. More specifically, in positions where respective steps of charging exposure to light, development, primary transfer, secondary transfer, and fixing are performed, timings during the image formation are different from each other. The pre-rotation step is a period, in which a preparation operation before the image forming step is performed, from input of the start instruction until the image is actually started to be formed. The sheet interval step is a period corresponding to between a recording material P and a (subsequent) recording material P when formation of images on the plurality of recording materials P is continuously performed (during continuous print). The post-rotation step is a period in which post-operation (preparation operation) after the image forming step is performed. During non-image formation (non-image-forming period) is a period other than during the image formation and includes the above-described pre-rotation step, the sheet interval step, and the post-rotation step, and in addition, includes the time of power-on of the image forming apparatus 100 or a pre-multi-rotation step which is a preparation operation during restoration from a sleep state, and the like step.

### 3. Optical Sensor

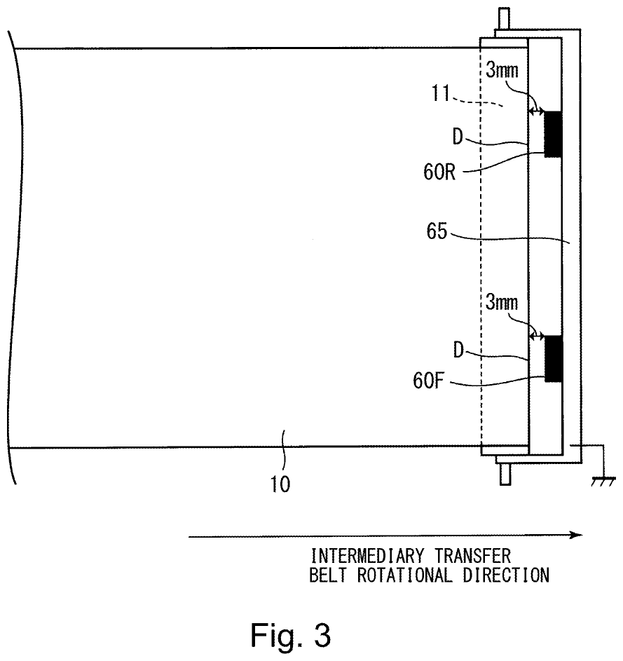

Next, a constitution of the optical sensor 60 will be described. FIG. 3 is a top plan view of the intermediary transfer belt 10 in the neighborhood of the optical sensors 60 (60F, 60R). Incidentally, as regards the image forming apparatus 100 and elements thereof, a sheet surface front side in FIG. 1 (lower side in FIG. 3) is a front side, and a sheet surface rear side in FIG. 1 (upper side in FIG. 3) is a rear side.

In this embodiment, the image forming apparatus 100 is provided with a front-side optical sensor 60F and a rear-side optical sensor 60R as the optical sensor 60. With respect to a widthwise direction substantially perpendicular to the movement direction of the surface of the intermediary transfer belt 10, the front-side optical sensor 60F is disposed on the front side than a center, and the rear-side optical sensor 60R is disposed on the rear side than the center. The optical sensor 60 (60F, 60R) is held by a holding member 65 constituted by a metal plate electrically grounded. The holding member 65 is supported by a rotation shaft of the first stretching roller 11 and is disposed so that a distance between the intermediary transfer belt 10 and the optical sensor 60 (60F, 60R) always becomes constant with respect to inclination of the first stretching roller 11. In this embodiment, the optical sensor 60 (60F, 60R) is disposed so that the distance with the intermediary transfer belt 10 becomes 3 mm.

In this embodiment, the front-side optical sensor 60F and the rear-side optical sensor 60R are substantially the same in constitution, and therefore, as a representative, the front-side optical sensor 60F will be described (F or R showing that the optical sensor is the front side optical sensor 60 or the rear-side optical sensor 60, respectively, will be appropriately omitted).

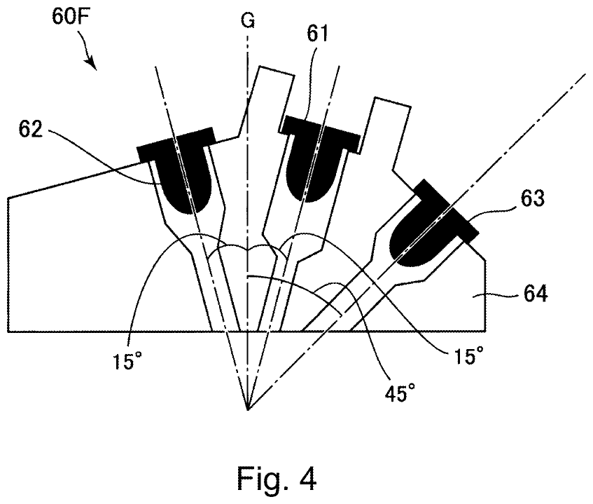

FIG. 4 is a sectional view for illustrating the constitution of the optical sensor 60. The optical sensor 60 is constituted by including a light emitting element 61, a first light receiving element 62, a second light receiving element 63, and a holder 64, or the like. The light emitting element 61 is constituted by an LED or the like. Further, each of the first light receiving element 62 and the second light receiving element 63 is constituted by a phototransistor or the like. In this embodiment, infrared light is emitted from the light emitting element 61, and the surface of the intermediary transfer belt 10 or a test pattern formed on the surface of the intermediary transfer belt 10 is irradiated with the infrared light. Then, reflected light from the surface of the intermediary transfer belt 10 or the test pattern formed on the surface of the intermediary transfer belt 10 is received by the first and second light receiving elements 62 and 63. In this embodiment, as the light emitting element 61, a light emitting element emitting infrared light with a wavelength of 800 nm as a peak was used, and as the first and second light receiving elements 62 and 63, a light receiving element with photosensitivity of a wavelength of 800 nm as a peak was used.

A normal line G in FIG. 4 is substantially perpendicular to the surface of the intermediary transfer belt 10. The light emitting element 61 is disposed so as to have inclination of 15° with respect to the normal line G. Further, a shape of a light guiding path is adjusted by the holder 64 so that a spot diameter when the intermediary transfer belt 10 is irradiated with the infrared light from the light emitting element 61 is 2 mm. The first light receiving element 62 is disposed so as to have inclination of 15° with respect to the normal line, and receives the infrared light specularly reflected or irregularity (diffusely) reflected from the surface of the intermediary transfer belt 10 or the test pattern. The second light receiving element 63 is disposed so as to have inclination of 45° with respect to the normal line, and receives the infrared light specularly reflected or irregularly reflected from the surface of the intermediary transfer belt 10 or the test pattern.

### 4. Detection Waveform of Reflected Light from Surface of Intermediary Transfer Belt by Optical Sensor

Next, a waveform (detection waveform) of a detection signal (detection output) indicating a detection result in the case where the reflected light from the surface of the intermediary transfer belt 10 is detected by the optical sensor 60 will be described. Here, the detection result acquired by the front-side optical sensor 60F will be described, but the same tendency is also seen for the detection result acquired by the rear-side optical sensor 60R (the same applies hereinafter for the detection signals of the optical sensors 60F and 60R). Further, F or R showing that the optical sensor is the front-side optical sensor 60 or the rear-side optical sensor 60, respectively, will be appropriately omitted.

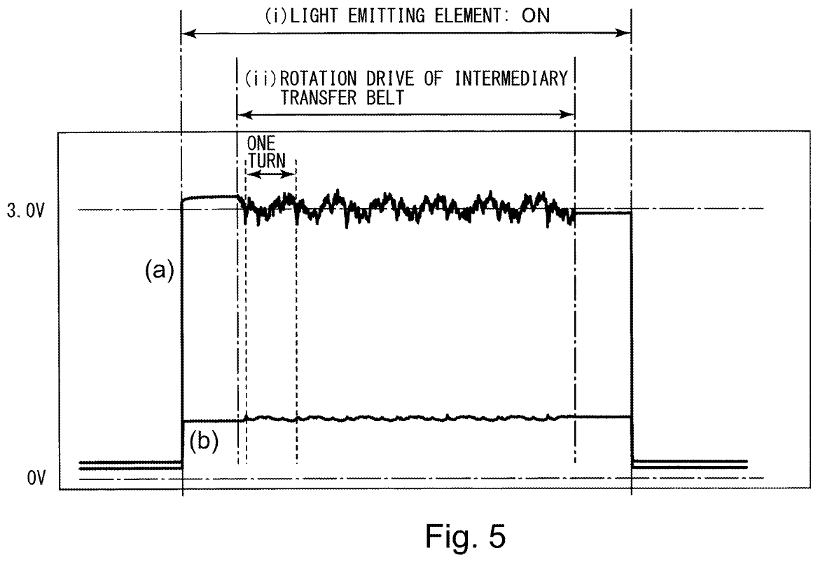

FIG. 5 is a graph showing detection waveforms in the case where reflected light from the surface of the intermediary transfer belt 10 is detected by the first and second light receiving elements 62 and 63. Incidentally, FIG. 5 shows the detection waveforms in the case where dew condensation does not generate inside the image forming apparatus 100. In FIG. 5, (a) is the detection waveform showing a detection result (specularly reflected light, diffused reflection light) by the first light receiving element 62, and in FIG. 5, (b) is the detection waveform showing a detection result (diffused reflection light) by the second light receiving element 63. In a section (i) in FIG. 5, the light emitting element 61 is driven, and as a result of detection of diffused light, although the detection result by the first light receiving element 62 is about 3.0 V, the detection result by the second light receiving element 63 is lower than this. That is, in the section (i), an amount of reflected light detected by the second light receiving element 63 is lower than an amount of reflected light detected by the first light receiving element 62. This is due to that most of the reflected light from the intermediary transfer belt 10 is the specularly reflected light. Incidentally, in this embodiment, in the case where the reflected light from the intermediary transfer belt 10 is detected by the first light receiving element 62, an amount of irradiating light of the light emitting element 61 and photosensitivity of the first light receiving element 62 are adjusted so that the detection result by the first light receiving element 62 becomes about 3.0 V. In this embodiment, the optical sensor 60 is constituted so that output of the detection signal indicating the detection result of the first light receiving element 62 becomes larger with a larger light reception amount. In a section (ii) in FIG. 5, it is understood that the intermediary transfer belt 10 is rotated and that the amounts of reflected light detected by the first and second light receiving elements 62 and 63 fluctuate depending on a surface property of the intermediary transfer belt 10.

### 5. Detection Waveform of Reflected Light from Toner Patch by Optical Sensor

Next, a waveform (detection waveform) of a detection signal (detection output) indicating a detection result in the case where the reflected light from the toner patch (a toner image for detection constituting the test pattern) on the intermediary transfer belt 10 was detected by the optical sensor 60 will be described.

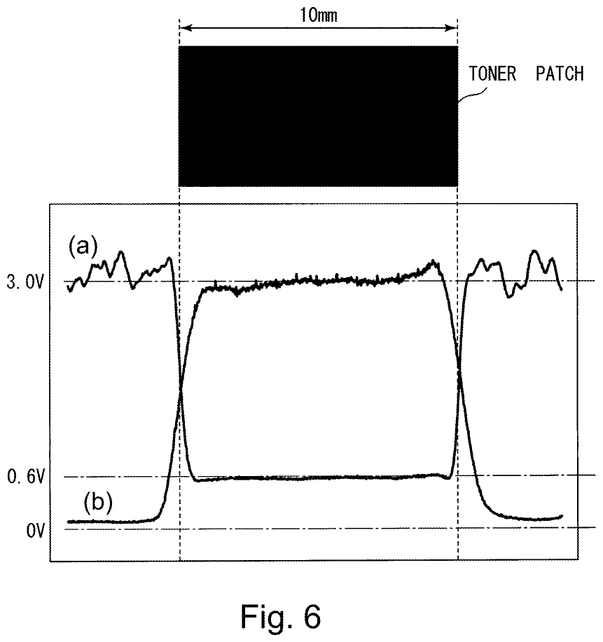

FIG. 6 is a graph showing detection waveforms in the case where as an example, reflected light from a solid yellow toner patch of 10 mm in length in the rotational direction of the intermediary transfer belt 10 was detected by the first and second light receiving elements 62 and 63. In FIG. 6, (a) is the detection waveform showing a detection result (specularly reflected light, diffused light) by the first light receiving element 62, and in FIG. 6, (b) is the detection waveform showing a detection result (diffused reflection light) by the second light receiving element 63.

First, the detection waveform ((a) in FIG. 6) by the first light receiving element 62 will be described. In a section in which the reflected light from the intermediary transfer belt 10 is detected, the first light receiving element 62 receives a large amount of the specularly reflected light, and therefore, the detection result by the first light receiving element 62 becomes about 3.0 V. However, in a section in which the toner patch is detected, the detection result by the first light receiving element 62 remarkably lowers and becomes about 0.6 V. This is because the reflected light from the toner patch principally consists of the diffused reflected light, and therefore, in the section in which the toner patch is detected, an amount of the reflected light reaching the first light receiving element 62 becomes smaller compared with that in a section in which the reflected light from the intermediary transfer belt 10 is detected.

Next, the detection waveform ((b) in FIG. 6) by the second light receiving element 63 will be described. Although the second light receiving element 63 hardly receives the reflected light from the intermediary transfer belt 10, the second light receiving element 63 detects the reflected light from the toner patch in a large amount, so that the detection result by the second light receiving element 63 becomes about 3.0 V. Incidentally, photosensitivity of the second light receiving element 63 is adjusted so that the detection result by the second light receiving element 63 becomes about 3.0 V, in this embodiment, in the case where the second light receiving element 63 detected the reflected light from the toner patch. In this embodiment, the optical sensor 60 is constituted so that output of the detection signal indicating the detection result by the second light receiving element 63 becomes larger with a larger light reception amount of the second light receiving element 63.

### 6. Detection of Reflected Light from Surface of Intermediary Transfer Belt During Print Job

### 6-1. Summary of Operation During Print Job

An operation in which the optical sensor 60 is driven during the print job in this embodiment and the reflected light from the surface (background) of the intermediary transfer belt 10 is detected will be described. As an example, a detection operation in the case where the front-side optical sensor 60F was used will be described.

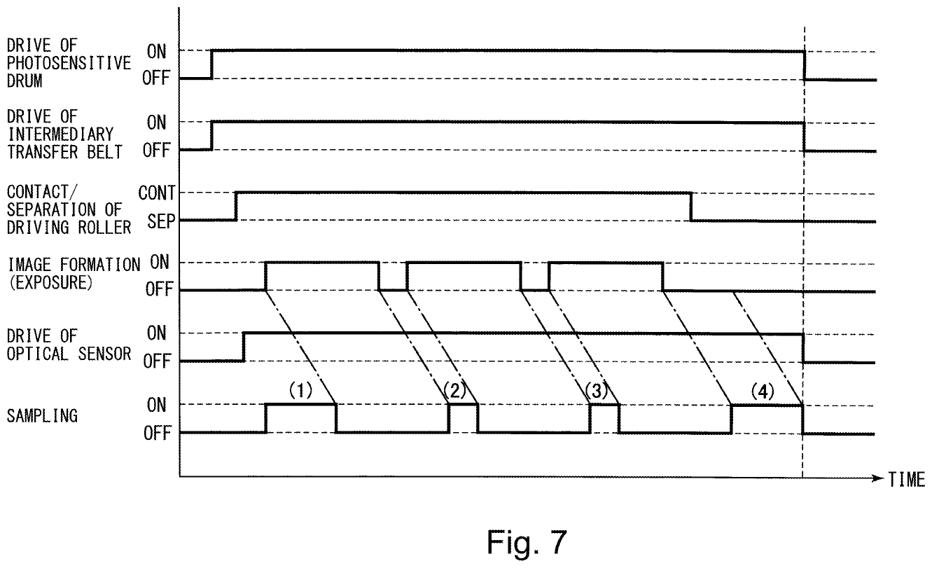

FIG. 7 is a timing chart showing an outline of operations of respective portions during the print job in this embodiment. FIG. 7 shows the outline of the operations of the respective portions in the case where a print job in which continuous printing is performed on three A4 (-size) sheets (herein, simply referred also to as a “print job for three sheets” or the like). In FIG. 7, a rotational drive timing of the photosensitive drum 1, a rotational drive timing of the intermediary transfer belt 10, a timing when the developing roller 42 is contacted to or separated from the photosensitive drum 1, a drive timing of the exposure device 3 for image formation, a drive timing of the optical sensor 60 (light emission timing of the light emitting element 61), and a sampling timing which is a data acquisition period for performing calculation processing of the detection result by the first light receiving element 62 are shown. In this embodiment, the photosensitive drums 1a, 1b, 1c, and 1d are rotated in synchronism with each other and rotations thereof are stopped. Further, in this embodiment, except for during a blank rotation operation described later, when the photosensitive drum 1 is rotated during the print job, charging processing of the surface of the photosensitive drum 1 by the charging roller 2 is substantially always performed. The operations in accordance with the timing chart of FIG. 7 are controlled by the DC controller 200. Incidentally, in this embodiment, although an operation of the print job in a full-color mode will be described as an example, an effect similar to that of this embodiment is obtained also in a print job in a monochromatic color mode.

When the print job is started, first, rotational drive of each of the photosensitive drums 1a, 1b, 1c, and 1d, and the intermediary transfer belt 10 is started, and subsequently, the developing roller 42 is contacted to the photosensitive drum 1. Incidentally, the contact of the developing roller 42 to the photosensitive drum 1 is adjusted in timing so that the developing roller 42 contacts the photosensitive drum 1 after the surface of the photosensitive drum 1 charged by the charging roller 2 reaches the developing position (contact portion between the photosensitive drum 1 and the developing roller 42). Further, the developing rollers 42a, 42b, 42c, and 42d contact the photosensitive drums 1a, 1b, 1c, and 1d, respectively at the same timing.

Next, after the developing roller 42 is contacted to the photosensitive drum 1, the image formation (exposure by the exposure device 3) is performed. In FIG. 7, the image formation becomes ON corresponding to a length in a conveying direction of the A4 sheet. This shows that the photosensitive drums 1a, 1b, 1c, and 1d are subjected to exposure to light depending on image signals by the exposure devices 3a, 3b, 3c, and 3d, respectively. In FIG. 7, timings of the image formation in the image forming portion Sa for yellow are shown as a representative, and timings of the image formation in the image forming portions for magenta, cyan, and black are somewhat delayed, respectively, in accordance with movement of the intermediary transfer belt 10. By this, on the photosensitive drums 1a, 1b, 1c, and 1d, electrostatic latent images corresponding to color component images for yellow, magenta, cyan, and black for objective color images are formed, respectively. These electrostatic latent images are supplied with toner by the developing rollers 42a, 42b, 42c, and 42d in the developing positions, respectively, so that toner images of the colors of yellow, magenta, cyan, and black are formed on the photosensitive drums 1a, 1b, 1c, and 1d, respectively. Further, the toner images formed on the photosensitive drums 1a, 1b, 1c, and 1d are successively transferred onto the intermediary transfer belt so as to be superposed on the same image forming region (toner image formable region) on the intermediary transfer belt 10. By this, predetermined images to be transferred onto recording materials P (three A4 sheets in an example of FIG. 7) are successively formed on the intermediary transfer belt 10. Incidentally, as described above, in this embodiment, in continuous printing in which print images are continuously formed on a plurality of recording materials P, an interval (sheet (paper) interval) between a trailing end of a preceding sheet and a leading end of a subsequent sheet is provided by 50 mm. For simplification, in this embodiment, a size of the image forming region on the intermediary transfer belt 10 is substantially the same as a size of the recording material P. Accordingly, in the continuous printing in which the print images are formed on the plurality of recording materials P, an interval (sheet interval) between a trailing end of a preceding image forming region and a leading end of a subsequent image forming region on the intermediary transfer belt 10 is provided by 50 mm. However, a size of the image forming portion on the intermediary transfer belt 10 may also be smaller than a size of the recording material P (a margin is generated on at least one of a leading end side and a trailing end side of the recording material P with respect to the conveying direction and one side and the other side of the recording material P with respect to a widthwise direction substantially perpendicular to the conveying direction). Further, the size of the image forming region on the intermediary transfer belt 10 may also be larger than the size of the recording material P (the image forming region protrudes from the recording material P on at least one of a leading end side and a trailing end side of the intermediary transfer belt 10 with respect to the rotational direction, and one side and the other side of the intermediary transfer belt 10 with respect to a widthwise direction of the intermediary transfer belt 10).

Further, in this embodiment, the optical sensor 60 is driven during the print job, and reflected light from the surface of the intermediary transfer belt 10 is detected. Further, in this embodiment, detection of the specularly reflected light from the surface of the intermediary transfer belt 10 by the first light receiving element 62 is performed.

6-2. Detection Timing of Reflected Light from Surface of Intermediary Transfer Belt During Print Job

A sampling timing of the detection result by the first light receiving element 62 will be described.

In this embodiment, the DC controller 200 executes sampling of the detection result by the first light receiving element 62 in sampling sections (1), (2), (3), and (4) in FIG. 7 during the print job. Further, in this embodiment, the DC controller 200 executes the sampling of the detection result by the first light receiving element 62 with an interval of 0.1 mm in the above-described sampling sections when the interval is viewed in terms of a surface movement distance of the intermediary transfer belt 10. The sampling section (1) in FIG. 7 is from a timing when the optical sensor 60 is driven and a rise of the light emitting element 61 was made to a timing when a leading end of an image forming region (herein, also referred to as an “image forming region for first sheet” or the like) in which the image is transferred onto a first sheet of the recording material P on the intermediary transfer belt 10 reaches a detecting position (position of a spot of the irradiating light of the light emitting element 61 with respect to the rotational direction of the intermediary transfer belt 10) D of the optical sensor 60. The sampling section (2) in FIG. 7 is from a timing when a trailing end of the image forming region for first sheet on the intermediary transfer belt 10 passed through the detecting position D of the optical sensor 60 to a timing when a leading end of an image forming region for a second sheet on the intermediary transfer belt 10 reaches the detecting position D of the optical sensor 60. Similarly, the sampling section (3) in FIG. 7 is from a timing when a trailing end of the image forming region for the second sheet on the intermediary transfer belt 10 passed through the detecting position D of the optical sensor 60 to a timing when a leading end of an image forming region for a third sheet on the intermediary transfer belt 10 reaches the detecting position D of the optical sensor 60. The sampling section (4) from passage of a trailing end of the image forming region for the third sheet on the intermediary transfer belt 10 through the detecting position D of the optical sensor 60 until drive of the intermediary transfer belt 10 becomes OFF.

Thus, in this embodiment, the DC controller 200 performs sampling of the detection result by the first light receiving element 62 at a timing avoiding a timing when the image forming region on the intermediary transfer belt 10 passes through the detecting position D of the optical sensor 60. This is because the amount of the reflected light from the surface of the intermediary transfer belt 10 is detect with accuracy without being influenced by the toner image on the intermediary transfer belt 10.

Incidentally, FIG. 7 is an example of the print job for the three sheets, but in the case where a print job for four sheets is performed, a sampling section, similar to the above-described sampling sections (2) to (3), between a trailing end of an image forming region for nth sheet on the intermediary transfer belt 10 and a leading end of an image forming region for (n+1)th sheet may only be required to be increased.

6-3. Detection Result of Reflected Light from Surface of Intermediary Transfer Belt in Case of No Dew Condensation

Next, a result of an experiment in which a relationship between the number of prints, the detection result by the first light receiving element 62, and a print image was investigated in the case where the dew condensation does not generate in the image forming apparatus 100 will be described. The detection waveform in the case where the reflected light from the surface of the intermediary transfer belt 10 was detected by the optical sensor 60 in a normal condition under which the dew condensation does not generate in the image forming apparatus 100 is as described using FIG. 5.

A table 1 shows a relationship between the detection result by the first light receiving element 62 and confirmation result of the print in which when a print job for 50 sheets is performed by using paper of 9.0 wt. % in water content as the recording material P in an environment of a temperature of 30° C. and a humidity (relative humidity) of 80%.

In the table 1, the detection result by the first light receiving element 62 shows an average value for 5 sheets. Here, this average value of the detection result by the first light receiving element 62 for the 5 sheets was acquired from a sampling result (sampling data) for 100 points in each of the numbers of prints. That is, in this embodiment, the DC controller 200 acquires an average value of the detection result (sampling data) of the reflected light from the surface of the intermediary transfer belt 10 during rotation of the intermediary transfer belt 10 corresponding to 10 mm in each number of prints (sampling section). Further, a sampling timing for the first sheet is a timing until the leading end of the image forming region for the first sheet on the intermediary transfer belt 10 reaches the detecting position D of the optical sensor 60, and corresponds to the sampling section (1) in FIG. 7. Sampling timings for from the second sheet to a 49th sheet are timings corresponding to the sampling section (2) or (3) in FIG. 7, and are sampling sections each between a trailing end of an image forming region for an associated number of prints on the intermediary transfer belt 10 and a leading end of a subsequent image forming region. A timing for a 50th sheet is a timing when a trailing end of an image forming region for the 50th sheet on the intermediary transfer belt 10 passes through the detecting position D of the optical sensor 60, and corresponds to the sampling section (4) in FIG. 7.

Further, here, repetitive printing was performed by using, as a set, 5 sheets in total including, as the print images, one sheet of a character image, one sheet of a half-tone image with a density of 0.8, one sheet of a solid image, and two sheets of solid with (image) in this order. Incidentally, image confirmation results are collectively shown for the numbers of prints at timings each when a character image which is a first print of the prints of the set of the 5 sheets is printed. For example, the confirmation results of the character image for the first sheet, the half-tone image for the second sheet, and the solid image for the third sheet are shown in a column of the first sheet.

In the table 1, in cells of the character (image), the half-tone (image), the solid (image), and another defect, image levels are shown by alphabets. “A” shows that there is absolutely no problem. “B” shows a slight image defects, and shows slight fade for the character, a density lower than a reference density in terms of an image density for the half-tone and the solid, and an occurrence of a slight toner smear for the anther defect. Incidentally, in the following description, a phenomenon that the image density becomes the density lower than the reference density is referred to as “poor density”. “C” shows a clear image defect, and shows clear fade for the character, clear poor density for the half-tone and the solid, and an occurrence of a toner smear for the another defect. Further, in a column for the 50th sheet, there is no confirmation result of an image quality, and therefore, “no data” is shown.

TABLE 1

| | | | | | | | |
|---|---|---|---|---|---|---|---|
| NOS^{*1} | 1 | 6 | 11 | 16 | 21 | 26 | 31 |
| DS^{*2}(V) | 3.2 | 3.1 | 3.1 | 3.0 | 3.2 | 3.0 | 3.1 |
| CHA^{*3} | A | A | A | A | A | A | A |
| HT^{*4} | A | A | A | A | A | A | A |
| SOL^{*5} | A | A | A | A | A | A | A |
| AD^{*6} | A | A | A | A | A | A | A |

| | | | | |
|---|---|---|---|---|
| NOS^{*1} | 36 | 41 | 46 | 50 |
| DS^{*2}(V) | 3.0 | 3.3 | 3.2 | 3.3 |
| CHA^{*3} | A | A | A | no data |
| HT^{*4} | A | A | A | no data |
| SOL^{*5} | A | A | A | no data |
| AD^{*6} | A | A | A | no data |

^{*1}“NOS” is the number of sheets (first to 50th).
^{*2}“DS” is the detection result.
^{*3}“CHA” is the character (image).
^{*4}“HT” is the half-tone (image).
^{*5}“SOL” is the solid (image).
^{*6}“AD” is the another defect.

As shown in the table 1, in a normal condition under which the dew condensation does not generate inside the image forming apparatus 100, the amount of reflected light from the intermediary transfer belt 10 is roughly constant, and therefore, even at either timing, an average value of the detection result by the first light receiving element 62 becomes about 3.0 V.

Further, as shown in the table 1, even in either number of prints, there was no problem in terms of the image quality.

6-4. Detection Waveform of Reflected Light from Surface of Intermediary Transfer Belt in Case of Presence of Dew Condensation

Next, a detection waveform in the case where the reflected light from the surface of the intermediary transfer belt 10 was detected by the optical sensor 60 in the case where water droplet were deposited on the surface of the intermediary transfer belt 10 by generation of the dew condensation in the image forming apparatus 100 will be described.

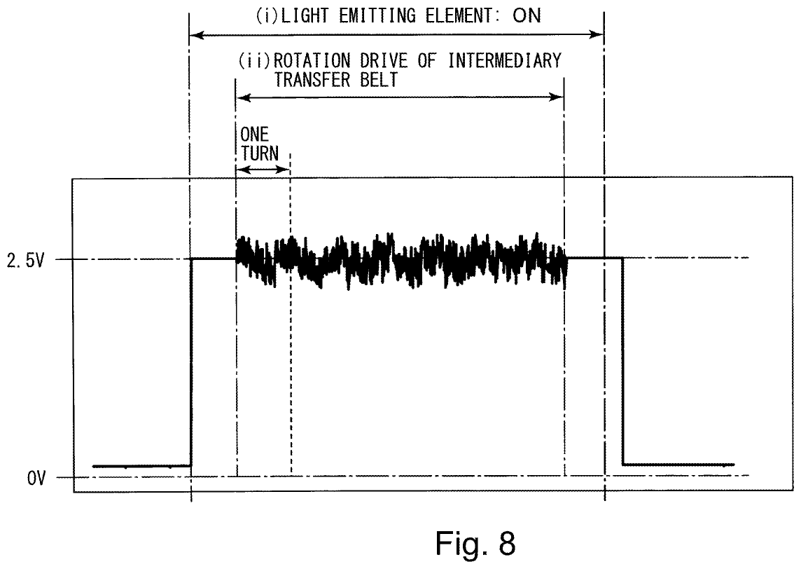

FIG. 8 is a graph showing a detection waveform in the case where the reflected light from the surface of the intermediary transfer belt 10 was detected by the first light receiving element 62 in a state in which the water droplets were deposited on the surface of the intermediary transfer belt 10 by generation of the dew condensation in the image forming apparatus 100. In a section (i) in FIG. 8, the light emitting element 61 is driven, and in a section (ii) in FIG. 8, the intermediary transfer belt 10 is rotationally driven. The amount of irradiating light of the light emitting element 61 and the photosensitivity of the first light receiving element 62 are set to values which are the same as those where the detection wavelength in the case where there is no dew condensation shown in FIG. 5 was acquired.

In the waveform of (a) in FIG. 5 in the case where a water film due to the dew condensation is not formed on the surface of the intermediary transfer belt 10, the average value of the detection result by the first light receiving element 62 is about 3.0 V. On the other hand, in the detection waveform of FIG. 8 in the case where the water film due to the dew condensation is formed on the surface of the intermediary transfer belt 10, an average value of the detection result by the first light receiving element 62 becomes about 2.5 V. This is because the amount of the reflected light reaching the first light receiving element 62 becomes small due to absorption of the irradiating light by the water droplets, a lowering in reflectance, a change in refractive index, and the like.

Further, when the detection waveform of (a) in FIG. 5 and the detection waveform of FIG. 8 are compared with each other, the detection waveform of FIG. 8 is larger in deviation of the detection result by the first light receiving element 62 in the section (ii) than the detection waveform of (a) of FIG. 5. This is because there is non-uniformity in deposition of the water droplets onto the surface of the intermediary transfer belt 10. Further, a detection pattern of a rotation period of the intermediary transfer belt 10 observed in the detection waveform of (a) of FIG. 5 is not observed in the detection waveform of FIG. 8. This is because the amount of the reflected light is changed due to the deposition non-uniformity of the water droplets and a surface state of the intermediary transfer belt 10 is hardly detected.

Thus, the amount of the reflected light from the surface of the intermediary transfer belt 10 detected by the first light receiving element 62 is lowered by the water droplets (water film) deposited on the surface of the intermediary transfer belt 10 due to the dew condensation. FIG. 8 is an example of a detection result in the case where the water droplets were deposited on the surface of the intermediary transfer belt 10. According to study by the present inventors, with a large amount of the water droplets deposited on the surface of the intermediary transfer belt 10, there is a tendency that the average value of the amount of reflected light (a detection result by the first light receiving element 62) from the surface of the intermediary transfer belt 10 becomes lower and deviation of the amount of reflected light (the detection result by the first light receiving element 62) becomes larger.

Here, the detection of the dew condensation state by using the optical sensor 60 in this embodiment is particularly effective in the case where glossiness of the surface of the intermediary transfer belt 10 is relatively high and in the case where uneven gloss is small. Specifically, the glossiness of the surface of the intermediary transfer belt 10 may preferably be 60 or more, further preferably be 80 or more. The glossiness of the surface of the intermediary transfer belt 10 may also be 100. Further, the uneven gloss may preferably be 30% or less in deviation further preferably be 20% or less, relative to an average value. In this embodiment, as described above, the glossiness of the surface of the intermediary transfer belt 10 is 75. Further, as described above, the glossiness of the surface of the intermediary transfer belt 10 can be measured by a commercially available measuring device, for example, the handy glossmeter IG-320 of HORIBA, Ltd. In order to discriminate between the reflected light from the surface of the intermediary transfer belt 10 and the reflected light from the water droplets deposited on the surface of the intermediary transfer belt 10, small uneven gloss of the surface of the intermediary transfer belt 10 is desirable because a difference between the reflected light beams is liable to generate. As a surface layer application method of the intermediary transfer belt 10 including such a surface layer high in glossiness and smaller in unevenness, it is possible to cite a dip coating, a ring coating, and the like.

6-5. Detection Result of Reflected Light from Surface of Intermediary Transfer Belt in Case of Presence of Dew Condensation

Next, a result (a relationship between the number of prints, the detection result by the first light receiving element 62, and the print image) in the case where an experiment similar to the experiment in which the above-described result of the table 1 is obtained in the case where the dew condensation does not generate was conducted in a condition under which the dew condensation generates will be described. Here, as a condition under which the dew condensation generates inside the image forming apparatus 100, in a condition under which are blowing from a ceiling by a ceiling fan is present, the experiment was conducted.

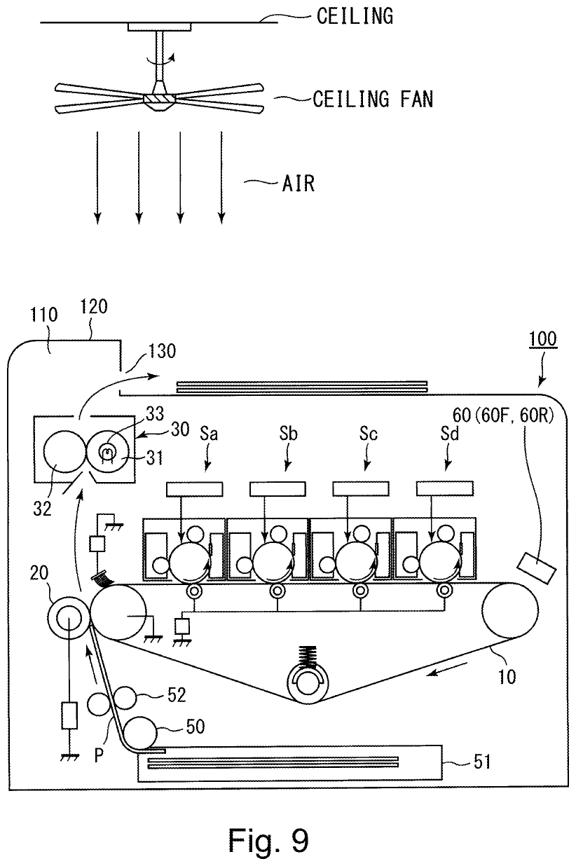

FIG. 9 is a (schematic) view showing a positional relationship between the image forming apparatus 100 and the ceiling fan in this experiment. The image forming apparatus 100 shown in FIG. 9 is an image forming apparatus having the same constitution as that of the image forming apparatus 100 of this embodiment shown in FIG. 1. In this experiment, the ceiling fan was installed right above the sheet (paper) discharge opening 130 of the image forming apparatus 100, and a print job was performed in a condition under which air blown from the ceiling fan becomes an air (wind) speed of 1.5 m/s in the neighborhood of the sheet discharge opening 130 of the image forming apparatus 100. Other conditions in this experiment are substantially the same as those in the experiment in which the above-described result of the table 1 was obtained.

A table 2 is a table in which a result of this experiment is summarized similarly as in the case of the table 1. Meanings of the alphabets shown in cells for the character (image), the half-tone (image), the solid (image), and the another defect are the same as those in the case of the table 1.

TABLE 2

| | | | | | | | |
|---|---|---|---|---|---|---|---|
| NOS^{*1} | 1 | 6 | 11 | 16 | 21 | 26 | 31 |
| DS^{*2}(V) | 3.2 | 3.0 | 2.8 | 2.7 | 2.5 | 2.5 | 2.4 |
| CHA^{*3} | A | A | A | A | A | A | A |
| HT^{*4} | A | A | A | B | B | B | B |
| SOL^{*5} | A | A | A | A | A | A | B |
| AD^{*6} | A | A | A | A | A | C | A |

| | | | | |
|---|---|---|---|---|
| NOS^{*1} | 36 | 41 | 46 | 50 |
| DS^{*2}(V) | 2.4 | 2.4 | 2.3 | 2.3 |
| CHA^{*3} | A | A | C | no data |
| HT^{*4} | C | C | C | no data |
| SOL^{*5} | B | C | C | no data |
| AD^{*6} | C | A | A | no data |

^{*1}“NOS” is the number of sheets (first to 50th).
^{*2}“DS” is the detection result.
^{*3}“CHA” is the character (image).
^{*4}“HT” is the half-tone (image).
^{*5}“SOL” is the solid (image).
^{*6}“AD” is the another defect.

From the table 2, it is understood that there is a tendency that the average value of the detection result by the first light receiving element 62 lowers in accordance with an increase in number of prints. This is due to the following reason. That is, water vapor generated from paper passed through the fixing device 30 is pushed back to the inside of the image forming apparatus 100 by the air, from the ceiling fan, entering through the sheet discharge opening 130 of the image forming apparatus 100. Then, this water vapor pushed back to the inside of the image forming apparatus 100 contacts the intermediary transfer belt 10 and the dew condensation generates, with the result that the amount of the reflected light detected by the first light receiving element 62 lowers as described using FIG. 8.

Further, as shown in the table 2, for the character image, a problem did not occur until the 41st sheet, but fade of the character occurred at the time of the 46th sheet.

Further, as shown in the table 2, for the half-tone image, a slight poor density was observed from the 16th sheet, and a conspicuous poor density was observed at the 36th sheet and later. This is because due to the dew condensation in the image forming apparatus 100, the dew condensation also generates on the surface of the photosensitive drum 1 and the surface potential of the photosensitive drum 1 is changed.

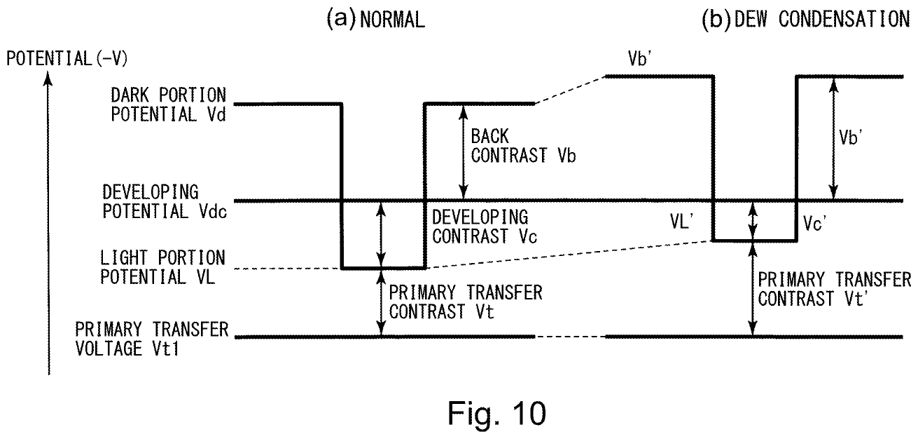

Here, a phenomenon that the poor density of the half-tone image occurs due to a change in surface potential of the photosensitive drum 1 will be described. FIG. 10 is a graph for illustrating the surface potential of the photosensitive drum 1.

FIG. 10(a) shows the surface potential of the photosensitive drum 1 under the normal condition that the dew condensation does not generate inside the image forming apparatus 100. The dark portion potential Vd is the surface potential of the photosensitive drum 1 after charged by the charging roller 2. Immediately after the surface of the photosensitive drum 1 passed through the charging position (roughly, the contact portion between the photosensitive drum 1 and the charging roller 2) by the charging roller 2 to which the charging voltage is applied (before the surface of the photosensitive drum 1 reaches an exposure position), the surface potential of the photosensitive drum 1 becomes the dark portion potential Vd by that the surface of the photosensitive drum 1 is uniformly charged. Thereafter, the surface of the photosensitive drum 1 is exposed in the exposure position to light depending on the image signal by the exposure device 3. By this, the surface potential of a portion (image portion) of the surface of the photosensitive drum 1 exposed to light by the photosensitive drum 1 becomes the light portion potential VL. Further, to the developing roller 42, a developing voltage Vdc is applied, and the toner on the developing roller 42 is moved onto the surface of the photosensitive drum 1 and deposited on the surface of the photosensitive drum 1 by a developing contrast which is a potential difference between the developing voltage (potential of the developing roller 42) and the light portion potential VL. Further, a back contrast Vb which is a potential difference between the dark portion potential Vd and the developing voltage Vdc has the influence on a so-called fog which is movement of the toner from the developing roller 42 onto a portion (non-image portion) of the dark portion potential Vd on the photosensitive drum 1. With a smaller back contrast Vb, there is a tendency that an amount of the toner causing the fog increases. For that reason, in the case where the half-tone image is formed, there is a tendency that the density of the half-tone image becomes thicker with the smaller back contrast Vb.

FIG. 10(b) shows the surface potential of the photosensitive drum 1 in the case where the dew condensation occurred on the surface of the photosensitive drum 1. The dew condensation on the surface of the photosensitive drum 1 is caused by movement of water due to the dew condensation on the surface of the intermediary transfer belt 10 to the surface of the photosensitive drum 1 or by direct contact of the air, from the ceiling fan, entering through the sheet discharge opening 130 of the image forming apparatus 100 with the surface of the photosensitive drum 1. Usually, surface charging of the photosensitive drum 1 by the charging roller 2 is formed by a discharge current from the charging roller 2 to the photosensitive drum 1. Such electric discharge generate in at least one of minute gaps formed between the charging roller 2 and the photosensitive drum 1 on sides upstream and downstream of the contact portion between the charging roller 2 and the photosensitive drum 1 in the rotational direction of the photosensitive drum 1. However, when the dew condensation occurred on the surface of the photosensitive drum 1, in addition to the discharge current, the current directly flows from the charging roller 2 to the photosensitive drum 1 in the contact portion between the charging roller 2 and the photosensitive drum 1. By this, a dark portion potential Vd′ which is the surface potential of the photosensitive drum 1 immediately after the photosensitive drum surface passed through the charging position (roughly, the contact portion between the photosensitive drum 1 and the charging roller 2) in the case where the dew condensation occurs becomes higher than the dark portion potential Vd in the case where the dew condensation does not occur. With this, a light portion potential VL′ in the case where the dew condensation occurs becomes higher than the light portion potential VL in the case where the dew condensation does not occur, so that a developing contrast Vc′ in the case where the dew condensation occurs becomes smaller than the developing contrast Vc in the case where the dew condensation does not occur. As a result, movement of the toner on the developing roller 42 to the photosensitive drum 1 decreases, so that the poor density of the half-tone image is caused.

Further, as shown in the table 2, for the solid image, slight poor density was observed from the 31st sheet, and conspicuous poor density was observed from the 41st sheet and later. The poor density of the solid image is caused due to that similarly as described above, the developing contrast Vc′ is decreased as shown in FIG. 10(b) and movement of the toner on the developing roller 42 to the photosensitive drum 1 is decreased. That is, when an amount of the movement of the toner on the developing roller 42 to the photosensitive drum 1 at the developing contrast Vc is taken as 100%, the amount of the movement in the case of the developing contrast Vc′ becomes less than 100%. Further, as shown in (a) and (b) of FIG. 10, compared with a primary transfer contrast Vt which is a potential difference between the light portion potential VL and a primary transfer voltage Vt1, a primary transfer voltage Vt′ in the case where the dew condensation occurs becomes large due to an increase in light portion potential VL′. By this, the discharge current generating between the photosensitive drum 1 and the intermediary transfer belt 10 becomes large. As a result, by inversion of the charge polarity of the toner on the intermediary transfer belt 10, or the like, a so-called re-transfer such that the toner primary transferred on the intermediary transfer belt 10 is returned to the photosensitive drum 1 occurs, so that poor density of the solid image occurs.

Further, as shown in the table 2, in addition to the poor density of the half-tone image and the poor density of the solid image, an image defect of toner smear caused by color mixing of yellow toner, magenta toner, cyan toner, and black toner was observed on the 26th sheet and 36th sheet. This is generated by that the toner deposited on the electroconductive brush 16 is absorbed by the water droplets on the intermediary transfer belt 10 and is transferred from the intermediary transfer belt 10 to the paper. When the image defect due to the toner smear occurs once, an amount of the toner deposited on the electroconductive brush 16 is decreased, and by subsequent printing, toner deposition onto the electroconductive brush 16 increases in amount again. For that reason, in a second half of the print job, the image defect results in random occurrence thereof.

### 6-6. Restoring Processing

In this embodiment, the image forming apparatus 100 performs detection of the amount of reflected light from the surface of the intermediary transfer belt 10 by the optical sensor 60 during the print job as described above. Then, the image forming apparatus 100 executes, as described later, dew condensation removal processing for eliminating the dew condensation state (for removing the water (moisture)) before the image defect due to the dew condensation occurs in the case where discrimination that the dew condensation occurred in the apparatus is made on the basis of the detection result. The dew condensation removal processing is an example of deposited matter removal processing for removing a deposited matter (water in this embodiment) on the surface of the intermediary transfer belt 10, as restoring processing from an abnormal state on the intermediary transfer belt 10. In this embodiment, the dew condensation removal processing is executed after interrupting the image formation in the print job. Then, the image forming apparatus 100 sufficiently remove the water on the photosensitive drum 1 and the intermediary transfer belt by the dew condensation removal processing, and thereafter resumes the image formation in the print job. Under the condition of the experiment in which the result of the table 2 was obtained, it is understood that after the printing for the 11th sheet is performed, the dew condensation removal processing may only be required to be performed by temporarily interrupting the printing (herein, also referred to as “interrupts the print job” without performing the printing for 12th sheet. Therefore, in this embodiment, on the basis of the result of the table 2, the image forming apparatus 100 interrupts the print job with a lowering in average value of the detection result by the first light receiving element 62 to 2.8 V as a trigger, and executes the dew condensation removal processing.

Incidentally, herein, an operation in which the detection result (detection signal) by the optical sensor 60 is thus acquired and control for executing predetermined processing such as the dew condensation removal processing is carried out is also simply referred to as detection (discrimination) of the dew condensation state. The same applies to that a foreign matter such as sand described later is detected.

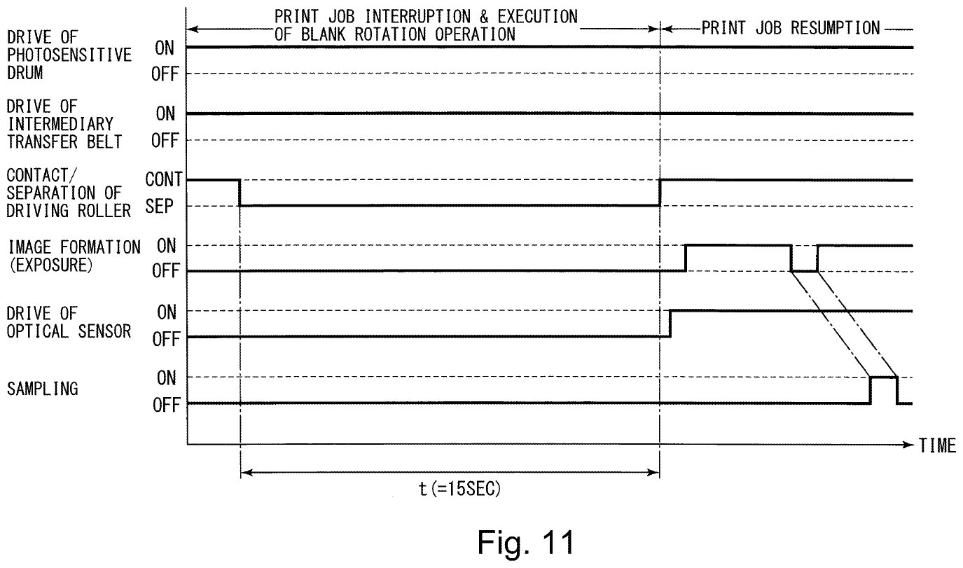

FIG. 11 is a timing chart showing an outline of operations of the respective portions. The operations in accordance with the timing chart of FIG. 11 are controlled by the DC controller 200.

In this embodiment, an operation for rotating the photosensitive drums 1a, 1b, 1c, and 1d and the intermediary transfer belt 10 for a predetermined time (herein, this operation is also referred to as a “blank rotation operation”) is executed. In this embodiment, a predetermined time t for which the blank rotation operation is continued was 15 sec.

Here, during the blank rotation operation, in order to suppress the movement of the water, deposited on the surface of the photosensitive drum 1, to the developing roller 42 and the developing device 4, it is preferable that the developing roller 42 is kept separated from the photosensitive drum 1. In the case where the developing roller 42 is separated from the photosensitive drum 1 during the blank rotation operation, it is not required to rotate the developing roller 42 and to applying the developing voltage to the developing roller 42 during the blank rotation operation. In this embodiment, the developing roller 42 is separated from the photosensitive drum 1 during the blank rotation operation, and the rotation of the developing roller 42 is stopped and the application of the developing voltage to the developing roller 42 is not performed. For example, in the case where the image forming apparatus 100 is not provided with a mechanism for separating the developing roller 42 from the photosensitive drum 1, or in the like case, a constitution in which the developing roller 42 is rotated in contact with the photosensitive drum 1 during the blank rotation operation may also be employed.

Incidentally, in this embodiment, the application of the charging voltage to the charging roller 2 is not performed during the blank rotation operation. However, during the blank rotation operation, charging bias application to the charging roller 2 similar to that during, for example, the image formation may also be performed. At this time, in a constitution in which the blank rotation operation is performed in a state in which the developing roller 42 is contacted to the photosensitive drum 1, a developing voltage similar to that during, for example, the image formation may also be applied to the developing roller 42. Further, in this embodiment, the intermediary transfer belt 10 contacts the photosensitive drums 1a, 1b, 1c, and 1d during the blank rotation operation. However, in the case where the image forming apparatus 100 is provided with a contact/separation mechanism capable of separating the intermediary transfer belt from at least one photosensitive drum 1, the intermediary transfer belt 10 may also be separated from at least one photosensitive drum 1 during the blank rotation operation. Further, in this embodiment, application of the primary transfer voltage to the primary transfer roller 6 is not performed during the blank rotation operation. However, application of a primary transfer voltage similar to that during, for example, the image formation to the primary transfer roller 6 may also be performed during the blank rotation operation. Further, in this embodiment, application of the secondary transfer voltage to the secondary transfer roller 20 is not performed during the blank rotation operation. However, application of a secondary transfer voltage similar to that during, for example, the image formation to the secondary transfer roller 20 may also be performed during the blank rotation operation.

In the experiment under a condition similar to that in the experiment in which the result of the table 2 was obtained, after the printing for the 11th sheet was performed, the print job was interrupted and the blank rotation operation was executed for 15 sec. Then, after the blank rotation operation was performed, the printing for the 12th sheet was resumed (herein, also referred to as “resumes the print job”). As a result, there is no occurrence of the slight poor density of the half-tone image, and the detection result by the first light receiving element 62 for the 16th sheet was 3.1 V. This is because by disappearance of the water droplets on the intermediary transfer belt 10, the irradiating light emitted by the light emitting element 61 is reflected by the surface of the intermediary transfer belt 10. The reason why the water droplets on the intermediary transfer belt 10 is caused to disappear by the blank rotation operation is that by deposition of the water droplets, on the intermediary transfer belt 10, onto the electroconductive brush 16, the secondary transfer roller 20, and the like, the water droplets are removed from on the intermediary transfer belt 10 and further a part of the water droplets is vaporized. Further, at this time, it would be considered that the image defect was capable of being suppressed by that the water droplets on the photosensitive drum 1 similarly disappeared. The reason why the water droplets on the photosensitive drum 1 are caused to disappear by the blank rotation operation is that the water on the photosensitive drum is transferred onto the intermediary transfer belt 10, and the water droplets on the intermediary transfer belt 10 are removed similarly as described above and a part of the water droplets is vaporized. Further, it would be considered that in the blank rotation operation, a part of the water droplets on the photosensitive drum 1 is also removed by the drum cleaning device 5.

Incidentally, in this embodiment, the blank rotation operation was executed for 15 sec, but an execution time of the blank rotation operation is not limited to this. The execution time of the blank rotation operation may only be required to be set appropriately in view of an assumed water droplet amount, a time required for removing the water droplets, and the like. As the execution time of the blank rotation operation, although it is not limited thereto, it is possible to exemplify about 5 sec~about 1 min, for example. In other words, as the execution time of the blank rotation operation, although it is not limited thereto, it is possible to exemplify a time in which the intermediary transfer belt makes about one turn~about 20 turns, for example. In this embodiment, a peripheral length of the intermediary transfer belt 10 is 800 mm, a peripheral speed of the intermediary transfer belt 10 is about 200 mm/sec, and a time in which the intermediary transfer belt 10 makes one turn is about 4 sec.

A lowering in detection result by the first light receiving element 62 with an increase in the number of prints shown in the table 2 and the occurrence timings of the image defect shown in the table 2 are examples, and these are changed by setting conditions such as a sets position, and an air (wind) speed of the ceiling fan. Further, the occurrence timing and a degree of the image defect is also changed by a constitution of the image forming apparatus 100, and is changed by, for example, a set value of the surface potential of the photosensitive drum 1, an electric resistance value of the intermediary transfer belt 10, a depositing force of the toner with these members, and the like. Accordingly, depending on a characteristic or the like of the image forming apparatus 100, on the basis of the detection result by the first light receiving element 62, the print job is interrupted and then the blank rotation operation of the intermediary transfer belt 10 may only be required to be performed.)

### 7. Control Procedure

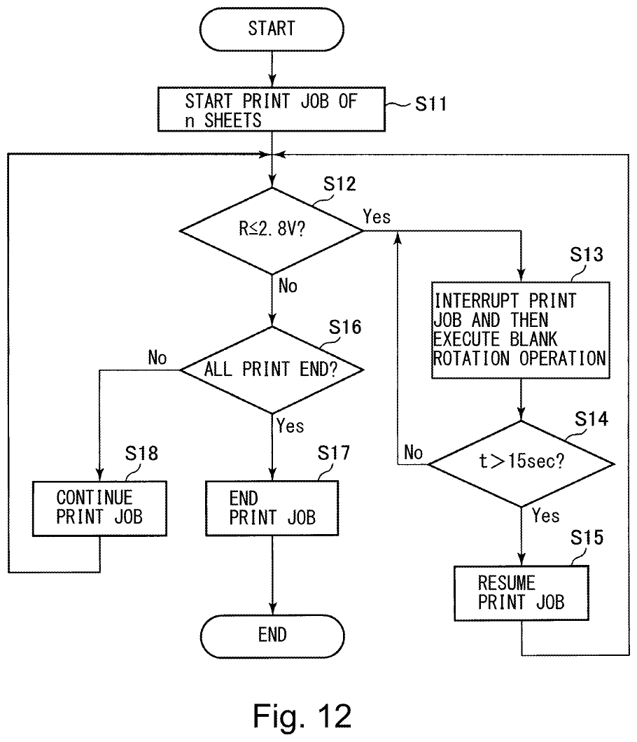

FIG. 12 is a flowchart showing an outline of an operation of the image forming apparatus 100 including a detecting operation of the dew condensation state and the dew condensation removal processing in this embodiment. The operation in accordance with the flowchart of FIG. 12 is controlled by the DC controller 200.

When a print job is instructed from the controller 210, the DC controller 200 starts the print job of n sheets (S11). Next, as the case where an average value R of the detection result by the first light receiving element 62 crosses over a threshold at a predetermined timing (sampling sections (1)~(4)) described using FIG. 7, the DC controller 200 discriminates whether or not the average value R is 2.8 V or less (S12). The case where the average value R of the detection result by the first light receiving element 62 is 2.8 V or less is an example of the case where a numerical value (voltage in this embodiment) related to a detection signal current after the light receiving element (first light receiving element 62 in this embodiment) of the optical sensor 60 receives the reflected light satisfies a predetermined condition. In the case where the DC controller 200 discriminated in S12 that the average value R of the detection result by the first light receiving element 62 is 2.8 V or less, the DC controller 200 interrupts the print job and executes the blank rotation operation (S13). Thereafter, the DC controller 200 discriminates whether or not a time t from a start of the blank rotation operation has elapsed by a predetermined time, 15 sec in this embodiment (S14). Then, in the case where the DC controller 200 discriminated in S14 that the time t does not elapse by 15 sec, the DC controller 200 executes the blank rotation operation continuously (S13). Further, in the case where the DC controller 200 discriminated in S14 that the time t has elapsed by 15 sec, the DC controller 200 ends the blank rotation operation, and resumes the print job (S15), and makes the discrimination of S12 again. On the other hand, in the case where the DC controller 200 discriminated in S12 that the average value R of the detection result by the first light receiving element 62 is larger than 2.8 V, the DC controller 200 discriminates whether or not all the prints of the print job are ended (S16). In the case where the DC controller 200 discriminated in S16 that all the prints of the print job is ended, the DC controller 200 ends the print job (S17). On the other hand, in the case where the DC controller 200 discriminated in S16 that all the prints of the print job are not ended, the DC controller 200 continues the print job (S18), and makes the discrimination of S12 again.

### 8. Effect

As described above, in this embodiment, the optical sensor 60 is driven during the print job, and the reflected light from the surface of the intermediary transfer belt 10 is detected by the first light receiving element 62, and then progression of the average value of the detection result is monitored. Particularly, in this embodiment, whether or not the average value of the detection result by the first light receiving element 62 becomes a predetermined threshold or less during the print job is monitored. By this, the dew condensation states of the surface of the intermediary transfer belt 10 and further the surface of the photosensitive drum 1 can be discriminated. In this embodiment, in the case where the average value of the detection result by the first light receiving element 62 became the threshold or less, dew condensation occurred on the surface of the intermediary transfer belt 10 and further on the surface of the photosensitive drum 1. Further, in this embodiment, in that case, the print job is interrupted before the image defect occurs, and the blank rotation operation for rotating the photosensitive drums 1a, 1b, 1c, and 1d, and the intermediary transfer belt 10 is performed. By this, even in a state in which the air by the ceiling fan enters the inside of the image forming apparatus 100 and in which the dew condensation occurs, the water droplets deposited on the photosensitive drum 1 and the intermediary transfer belt 10 are removed, so that a good image quality can be maintained throughout the print job. That is, according to this embodiment, it is possible to suppress the occurrence of the image defect due to the deposition of the water droplets, on the photosensitive drum 1 and the intermediary transfer belt 10, generating during the print job.

### 9. Modified Embodiments

In the following, modified embodiments of this embodiment will be described.

### 9-1. Modified Embodiment of Dew Condensation State Detecting Method and Dew Condensation Removal Processing

In this embodiment, the DC controller 200 had the constitution in which the blank rotation operation is executed for the predetermined time set in advance, but the present invention is not limited to such a constitution. For example, the DC controller 200 may also employ a constitution in which the execution time of the blank rotation operation is adjusted depending on a speed of a fluctuation in average value by the first light receiving element 62 during the print job (fluctuation amount per unit time, fluctuation amount per unit number of prints, or the like). In this case, for example, the DC controller 200 is capable of carrying out control so that the execution time of the blank rotation operation is increased with a faster speed of the fluctuation in average value by the first light receiving element 62 during the print job.

Further, the dew condensation removed processing is not limited to the blank rotation operation. For example, the image forming apparatus may be stopped for a predetermined time until the water droplets on the photosensitive drum 1 and the intermediary transfer belt 10 are vaporized and the dew condensation state is sufficiently eliminated similarly as in this embodiment. Incidentally, the stop of the image forming apparatus 100 refers to a stop of at least the photosensitive drums 1a, 1b, 1c, and 1d, the intermediary transfer belt 10, and the members (charging roller 2, developing roller 42, and the like) acting on these. Accordingly, for example, a fan as an air blowing means for inhaling or exhausting the air inside or outside the image forming apparatus 100, a heater as a heating means, a control means, and the like may be operated. An outline of an operation of the image forming apparatus 100 in this case is similar to that described using the flowchart of FIG. 12, but in S13, after the print job is interrupted, the image forming apparatus 100 is to be stopped.

Further, during the blank rotation operation as the dew condensation removal processing or during stop of the image forming apparatus 100, for example, by heating the heating means such as the heater of the fixing device 30, an inside temperature of the image forming apparatus 100 is raised, so that it is also possible to promote vaporization of the water droplets generated by the dew condensation. The heating means is not limited to the heater of the fixing device 30, and may also be a heater provided for heating an arbitrary portion, of the image forming apparatus 100, such as the photosensitive drum 1, or a heater provided particularly for eliminating the dew condensation state, or the like. Further, during the blank rotation operation or during the stop of the image forming apparatus 100, for example, air intake or air exhaust by the fan as the air flowing means for inhaling or exhausting the air inside or outside the image forming apparatus 100 is performed, so that it is possible to promote discharge of the water, generated by the evaporation of the water droplets, to the outside of the image forming apparatus 100.

Further, in this embodiment, the print job is interrupted and the dew condensation removal processing (the blank rotation operation in this embodiment) was executed, but the dew condensation removal processing may also be executed after a series of prints (image formation) in the print job is ended. In this case, for example, under a condition similar to that in the experiment in which the result of the table 2 was obtained, in the case of a print job of 20 sheets, only the slight poor density of the half-tone image is generated, but conspicuous image defect does not occur for other images. Further, in a subsequent print job, the dew condensation is removed, and therefore, a good image can be obtained. Thus, by executing the dew condensation removal processing when the print job is ended, there is an advantage such that the occurrence of the image defect can be suppressed to a slight one without generating down time (a period in which the image cannot be output) during the print job.

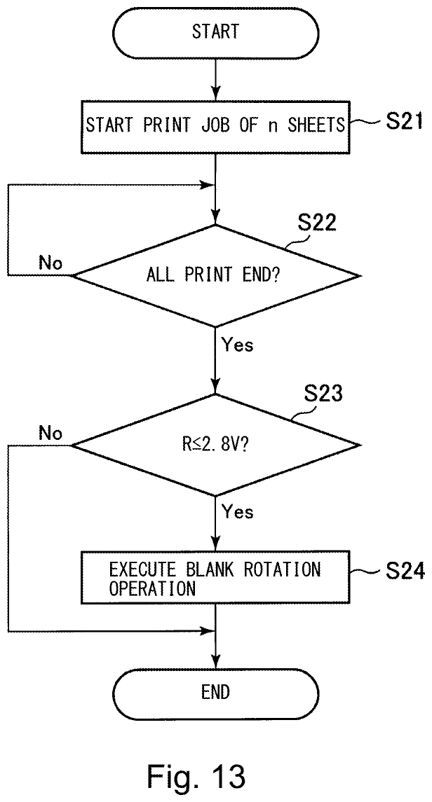

FIG. 13 is a flowchart showing an outline of an operation of the image forming apparatus 100, including a dew condensation state detecting operation and dew condensation removal processing in this case. An operation in accordance with the flowchart of FIG. 13 is controlled by the DC controller 200. When a print job is instructed from the controller 210, the DC controller 200 starts the print job of n sheets (S21). Next, the DC controller 200 discriminates whether or not all prints of the print job are ended (S22). In the case where the DC controller 200 discriminated in S22 that all the prints of the print job are ended, the DC controller 200 discriminates whether or not an average value R of a detection result by the first light receiving element 62 is 2.8 V or less in the sampling section (4) described using FIG. 7 (S23). In the case where the DC controller 200 discriminated in S23 that the average value R of the detection result by the first light receiving element 62 is 2.8 V or less, the DC controller 200 executes the blank rotation operation when the print job is ended, and thereafter executes a normal post-rotation step, so that the print job is ended (S24). That is, in this embodiment, when the print job is ended, a time from passage of a trailing end of an image forming region for a final page on the intermediary transfer belt 10 passes through the detecting position D until the rotation of the intermediary transfer belt 10 is stopped becomes longer than that in the case where only the normal post-rotation step is executed. Further, in the case where the DC controller 200 discriminated in S23 that the average value R of the detection result by the first light receiving element 62 is higher than the 2.8 V, the DC controller 200 executes the normal post-rotation step without executing the blank rotation operation, and ends the print job. Incidentally, in the case where the operation of the image forming apparatus 100 is stopped as the dew condensation removal processing when the print job is ended, even in the case where a subsequent print job is instructed, the DC controller 200 may only be required to postpone (prohibit) a start of the print job until a predetermined stop time has elapsed.

Further, the DC controller 200 may also be constituted so as to select whether to execute the dew condensation removal processing after interrupting the print job or the dew condensation removal processing when the print job is ended. For example, at the time of start of the print job, the DC controller 200 is capable of discriminating whether or not a predetermined image (for example, the half-tone image) with a possibility of occurrence of the poor density during the print job is formed, on the basis of image data received by the controller 210. Then, the DC controller 200 is capable of carrying out control so as to execute an operation of FIG. 13 (execute the dew condensation removal processing when the print job is ended) in the case where a corresponding image is absent and so as to execute an operation of FIG. 12 (execute the dew condensation removal processing after interrupting the print job) in the case where the corresponding image is present. Incidentally, at the time when the dew condensation state is detected by executing the operation of FIG. 12, the DC controller 200 may also determine whether to execute the dew condensation removal processing after interrupting the print job or the dew condensation removal processing when the print job is ended, depending on whether or not then the predetermined image (for example, the half-tone image) with the possibility of the occurrence of the poor density is formed. Incidentally, the half-tone image is not limited to that used in the above-described experiment example, but for example, in the case where a toner application amount (area ratio) of a solid image is 100%, the half-tone image is an image of about 20%~80% in toner application amount (area ratio). Further, for example, the DC controller 200 may also select whether to execute the dew condensation removal processing after interrupting the print job or the dew condensation removal processing when the print job is ended, depending on the number of prints of the print job. In this case, for example, the dew condensation removal processing can be executed after interrupting the print job in the case where the number of prints of the print job is a predetermined number of sheets or more, and the dew condensation removal processing can be executed when the print job is ended in the case where the number of prints of the print job is less than the predetermined number of sheets. Selection similar to the above-described selection may be made on the basis of a remaining number of prints at the time when the dew condensation state was detected.

Further, in this embodiment, description was made on the assumption that the detection result of the amount of the reflected light from the surface of the intermediary transfer belt 10 by the first light receiving element 62 when the water droplets are not deposited on the intermediary transfer belt 10 is about 3.0 V. However, for example, there is a possibility that resultant output of the first light receiving element 62 is fluctuated by a light emission amount of the light emitting element 61, a sensitivity setting of the first light receiving element 62, soiling of the light emitting element 61 and the first light receiving element 62 and the second light receiving element 63, and the like. For that reason, the detection result of the amount of the reflected light from the surface of the intermediary transfer belt 10 by the first light receiving element 62 at the time of the start of the print job is not necessarily required to be about 3.0 V. Further, for example, the DC controller 200 acquires an average value of the detection result of the amount of the reflected light from the surface of the intermediary transfer belt 10 by the first light receiving element 62 at the time of the start of the print job, and causes the memory 202 to store the acquired average value as an initial value. As the initial value of the detection result by the first light receiving element 62 at the time of the start of the print job, for example, the value acquired in the above-described sampling section (1) can be used. Then, the DC controller 200 is capable of discriminating whether or not the dew condensation state is formed, on the basis of a change amount from the initial value of the detection result by the first light receiving element 62 during the print job. In this case, for example, when 0.2 V corresponding to a difference between the initial value of 3.0 V and the threshold of 2.8 V in this embodiment is used as a threshold, it is possible to discriminate that the dew condensation state is formed in the case where the above-described change amount becomes the threshold (0.2 V) or more. Or, whether or not the dew condensation state is formed may also be discriminated on the basis of a proportion of the change amount in detection result by the first light receiving element 62 to the above-described initial value or a maximum value. For example, in the case where the average value of the detection result by the first light receiving element 62 is lowered relative to the initial value or the maximum value by a little less than 10% (for example, 7%), it is possible to discriminate that the dew condensation state is formed. Thus, a degree of a lowering (change amount, for example, a difference or a proportion), from the initial value at the time of the start of the print job, of the average value of the detection result by the first light receiving element 62 during the print job may be monitored. Also, by this, an effect similar to the effect of this embodiment can be obtained.

Further, in this embodiment, as the detection result by the first light receiving element 62, an average value of a sampling result (sampling data) for 100 points was calculated, and a change in average value was utilized as a discriminating means for the dew condensation state. However, the number of sampling points used as the average value is not limited to the number of sampling points in this embodiment, but may only be required to be appropriately set depending on desired discrimination accuracy of the dew condensation state. Further, as the discriminating means for the dew condensation state, it is possible to use deviation, not the average value. As an example, the following formula (1) is a calculation expression of the deviation, in which xj is an i-th detection signal, u is the average value, and n is the number of sampling points and is 100 in the case of this embodiment.

$$S = {\sum }_{i = 1}^{n} \{ \frac{\vert {x}_{i} - μ \vert}{n} \} \qquad formula ( 1 )$$

By discriminating the dew condensation state by the deviation, in the case where the water droplets deposited on the intermediary transfer belt 10 are sparse, there is an advantage that the value is changed with high sensitivity compared with calculation of the average value in some cases. For example, in the case where the calculated deviation is a predetermined threshold or more, it is possible to discriminate that the dew condensation state is formed. Further, both the average value and the deviation may be used. For example, in the case where the average value is the predetermined threshold or less (or the change amount in average value is the predetermined threshold or more) and the deviation is the predetermined threshold or more, it is possible to discriminate that the dew condensation state is formed.

### 9-2. Modified Embodiment of Detection Timing of Dew Condensation State

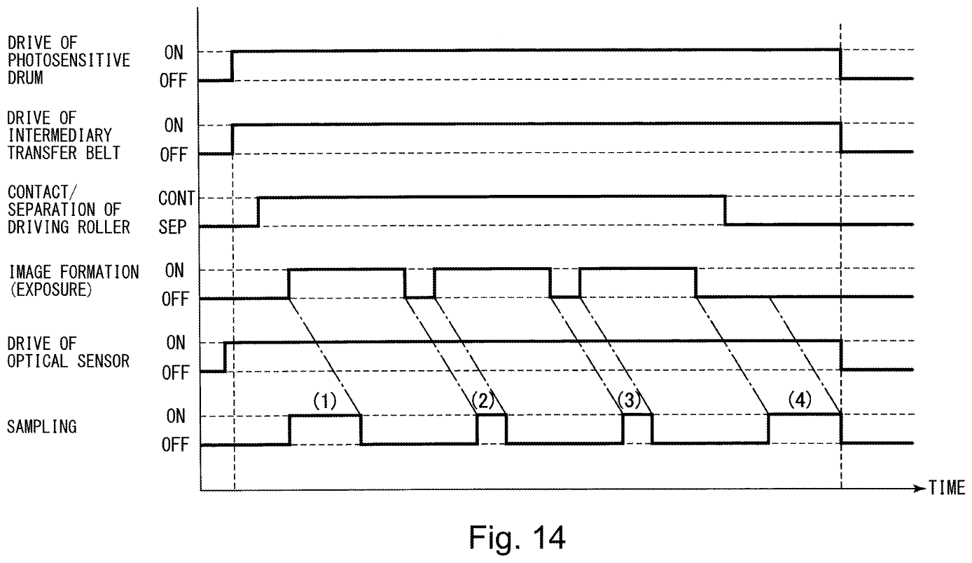

FIG. 14 is a timing chart showing an outline of an operation of the respective portions during a print job in one modified embodiment. The operation in accordance with the timing chart of FIG. 14 is controlled by the DC controller 200. For example, in the case where there is a need to sufficiently ensure warm-up (rise) time of the light emitting element 61 or in the like case, as shown in FIG. 14, the optical sensor 60 may be driven in advance of drive of the intermediary transfer belt 10. In this case, for example, in view of the warm-up time of the light emitting element 61, image formation can be started so that detection of the dew condensation state can be performed in the above-described sampling sections (1), (2), (3), and (4). Other points of the operation in accordance with the timing chart of FIG. 14 are substantially the same as those of the operation in accordance with the above-described timing chart of FIG. 7.

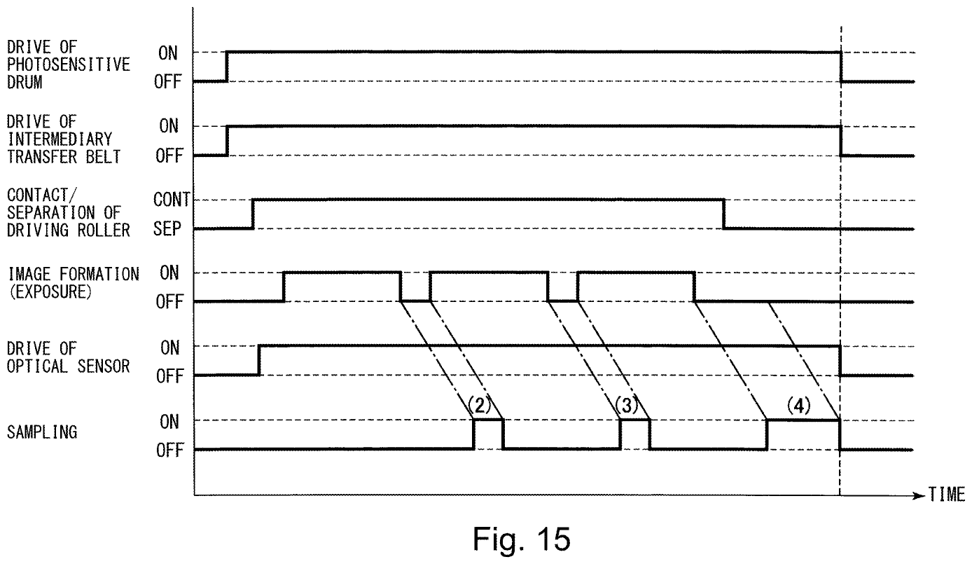

Further, FIG. 15 is a timing chart showing an outline of an operation of the respective portions during a print job in another modified embodiment. The operation in accordance with the timing chart of FIG. 15 is controlled by the DC controller 200. The dew condensation due to the air from the ceiling fan is generated by water vapor generated from paper passed through the fixing device 30, and therefore, a possibility that the water droplets are deposited on the intermediary transfer belt 10 during the image is formed on a first sheet is low. In view of this, for example, as shown in FIG. 15, acquisition of the detection result by the first light receiving element 62 may be started from the sampling section (2) between the trailing end of the image forming region for the first sheet and the leading end of the image forming region for the second sheet on the intermediary transfer belt 10. That is, in an example of FIG. 15, the detection result by the first light receiving element 62 is acquired in the sampling sections (2), (3), and (4). In this case, for example, it is possible to discriminate that the dew condensation state is formed in the case where the average value of the detection results by the first light receiving element 62 in the sampling sections (2), (3), and (4) became the predetermined threshold or less. Or, as described above, the average value of the detection result by the first light receiving element 62 in the sampling section (2) is used as the initial value, and on the basis of a change amount of the average value of the detection results in the sampling sections (3) and (4) from this initial value, the dew condensation state can be discriminated. By starting the detection from the sampling section (2), it becomes possible to carry out the image formation without waiting the warm-up of the light emitting element 61. Other points of the operation in accordance with the timing chart of FIG. 15 are substantially the same as those of the operation in accordance with the above-described timing chart of FIG. 7.

Further, in this embodiment, in order to discriminate the dew condensation state when the print job is ended, the drive of the optical sensor 60 and the sampling of the detection result were performed also in the sampling section (4). By this, as needed, the dew condensation removal processing is executed when the print job is ended, so that it is possible to suppress the influence by the dew condensation when a subsequent print job is started. However, the present invention is not limited to this, but the sampling of the detection result of the optical sensor 60 and further drive of the optical sensor 60 in the sampling section (4) are not required to be performed. Also, in that case, on the basis of the detection results of the optical sensor 60 in the sampling section (2) or (3) and further in the sampling section (1), the influence by the dew condensation in the print job can be suppressed. Further, in this embodiment, as in the sampling section (2) or (3), the sampling of the detection result of the optical sensor 60 was performed in all the sheet intervals on the intermediary transfer belt 10. By this, progress of the dew condensation can be grasped more quickly. However, the present invention is not limited to this, but for example, the sampling of the detection result of the optical sensor 60 may also be performed in a part of the sheet interval regions in such a manner that the sampling of the detection result of the optical sensor 60 is performed in a sheet interval region, for every predetermined number of sheets, as the sampling section (2) or (3). In that case, in the case where there is a possibility in relation to the warm-up of the optical sensor 60 or the like, the drive (light emission) of the optical sensor 60 may be stopped between sheet intervals each in which the sampling of the detection result of the optical sensor 60 is performed.

Further, in this embodiment, in all the print jobs, in order to make discrimination of the dew condensation state with use of the optical sensor 60, the image forming apparatus 100 drove the optical sensor 60 and performed sampling of the print of the optical sensor 60. However, the present invention is not limited to this. The image forming apparatus 100 may be possible to execute the print job by switching a detection mode (first mode) in which discrimination of the dew condensation state by using the optical sensor 60 is made and a normal mode (second mode) in which this (optical sensor 60) is not used. A discrimination method of the dew condensation state by using the optical sensor 60 in the above-described detection mode may also be similar to that in this embodiment. For example, the controller (control portion) 200 can switch the above-described detection mode and the above-described normal mode before the start of the print job or during execution of the print job, depending on an environment. Here, the environment may be a temperature or a humidity on at least one of an inside and an outside of the image forming apparatus 100. As an example, the controller 200 acquires a detection result of the environment by an environment sensor (not shown) provided to the image forming apparatus 100. Then, on the basis of the detection result of the environment, the controller 200 is capable of carrying out control so as to execute the print job in the above-described detection mode in the case where the temperature outside the image forming apparatus 100 is 30° C. or more, preferably in the case where the temperature is 30° C. or more and the humidity (relative humidity) is 80% or more. Further, the controller 200 is capable of carrying out control so as to execute the print job in the above-described normal mode in the case where the temperature is less than 30° C., preferably in the case where the temperature is less than 30° C. and the humidity (relative humidity) is less than 80%. According to the method described in this embodiment, the discrimination of the dew condensation state with use of the optical sensor 60 can be executed in a period corresponding to the sheet interval step during the execution of the print job. For that reason, except for the case where periods of the sheet interval step and the post-rotation step are extended due to the dew condensation removal processing, if conditions other than the condition relative to the switching of the above-described mode are substantially the same, between the above-described detection mode and the above-described normal mode, lengths of the sheet interval step and the post-rotation step are substantially the same.

### 9-3. Modified Embodiment of Constitution of Image Forming Apparatus

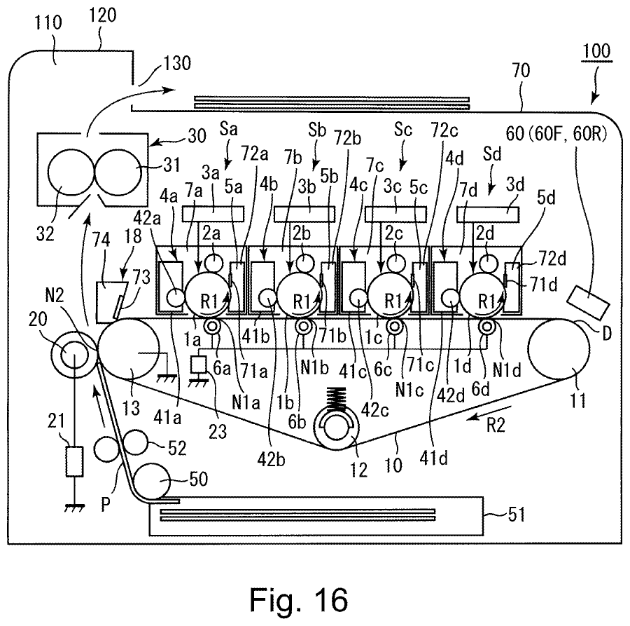

In this embodiment, the image forming apparatus 100 had the constitution in which a deposited matter such as secondary transfer residual toner remaining on the intermediary transfer belt 10 after the secondary transfer is removed by using the electroconductive brush 16, but the present invention is not limited to such a constitution. FIG. 16 is a schematic sectional view of an image forming apparatus of one modified embodiment. In the image forming apparatus of FIG. 16, elements having identical or corresponding functions or constitutions to those of the elements in the image forming apparatus of FIG. 1 will be omitted from detailed description by adding thereto the same symbols as those in the image forming apparatus of FIG. 1. The image forming apparatus 100 at FIG. 16 includes a belt cleaning device 18 as an intermediary transfer member cleaning means, in a position opposing the third stretching roller 13 on the outer peripheral surface side of the intermediary transfer belt 10. The belt cleaning device 18 includes a cleaning blade 73 as a cleaning member disposed in contact with the surface of the intermediary transfer belt 10 and a cleaning container 74 for accommodating the deposited matter such as the secondary transfer residual toner removed from the surface of the intermediary transfer belt by the cleaning blade 73. The belt cleaning device 18 scrapes off the deposited matter such as the secondary transfer residual toner from the surface of the rotating intermediary transfer belt 10 by the cleaning blade 73, and accommodates the deposited matter in the cleaning container 74. The present invention is also capable of being applied to the image forming apparatus 100 having such a constitution.

### 9-4. Modified Embodiment Related to Reflected Light to be Detected

In this embodiment, the detection of the dew condensation state was performed on the basis of the detection result by the first light receiving element 62 of the optical sensor 60. This is because the irradiating light emitted by the light emitting element 61 is reflected principally as specularly reflected light by the intermediary transfer belt 10. However, for example, in the case where glossiness of the surface of the intermediary transfer belt 10 is low or in the case where the intermediary transfer belt 10 has tint including a white component, the case where the above-described irradiating light is reflected principally as diffused reflection light, not the specularly reflected light, by the intermediary transfer belt 10 would be considered. In this case, it is also possible to detect the dew condensation state on the basis of a detection result by the second light receiving element 63. Further, also in the case where it is assumed that as a foreign matter other than the water droplets, sand (sand dust, sand dirt) and toner which is not originally present in a region other than the image forming region are deposited on the intermediary transfer belt 10, or in the like case, it becomes possible to use the detection result by the second light receiving element 63 (see embodiment 3).

Thus, in this embodiment, the image forming apparatus 100 includes the toner image forming means (the charging roller 2, the exposure device 3, the developing device 4, and the like) for forming the toner image; the rotatable image bearing member (intermediary transfer belt) 10 for bearing, on the surface thereof, the toner image formed by the toner image forming means; the transfer means (the secondary transfer roller 20 or the like) for transferring, onto the recording material P, the toner image formed on the surface of the image bearing member 10; and the optical sensor 60 which includes the light emitting element 61 for emitting the light toward the surface of the image bearing member 10 and the light receiving elements 62 and 63 (the first light receiving element 62 in this embodiment) for receiving the reflected light reflected by emitting the light from the light emitting element 61 toward the surface of the image bearing member 10 and for outputting the detection signal depending on the light reception amount and which is for detecting the reflected light in the detecting position D in the movement direction of the surface of the image bearing member 10, and executes the print job in which the print image is formed on the single or the plurality of recording materials P by one start instruction and the single or the plurality of recording materials P are discharged from the inside to the outside of the image forming apparatus through the recording material discharge opening (sheet discharge opening) 130. Further, in this embodiment, the image forming apparatus 100 includes the controller (DC controller) 200 capable of carrying out control so as to execute the deposited matter removal processing (dew condensation removal processing) for removing the deposited matter (dew condensation) on the surface of the image bearing member 10 during execution of the print job on the basis of the detection signal output after receiving the reflected light by the light receiving element 62 in a period from passage, through the detecting position D, of the trailing end of the image forming region of the surface of the image bearing member 10 with respect to the movement direction, where the toner image to be transferred onto the preceding recording material P is formable until the leading end of the image forming region of the surface of the image bearing member 10 with respect to the movement direction, where the toner image to be transferred onto the subsequent recording material P is formable reaches the detecting position D. In this embodiment, the controller 200 carries out control of the driving portion 90 for rotationally driving the image bearing member 10 so that as the deposited matter removal processing, a blank rotation operation for rotating the image bearing member 10 without forming the toner image on the surface of the image bearing member 10 is executed. In this embodiment, the controller 200 carries out the control of the driving portion 90 so as to execute the blank rotation operation over a predetermined time. However, the controller 200 can also carry out control of the driving portion 90 for rotationally driving the image bearing member 10 so that as the deposited matter removal processing, rotation of the image bearing member 10 is maintained in a stopped state for a predetermined time. Further, in this embodiment, the controller 200 executes the deposited matter removal processing after interrupting formation of the toner image on the surface of the image bearing member 10 in the print job. However, the controller 200 can also execute the deposited matter removal processing after formation of all of toner images on the surface of the image bearing members 10 in the print job is ended.

Further, in this embodiment, during execution of the print job, the controller 200 is further capable of carrying out the control on the basis of a detection signal output after receiving the reflected light by the light receiving element 62 after a trailing end of an image forming region of the surface of the image bearing member 10 with respect to the movement direction, where the toner image to be transferred onto the final recording material P in the print job is formable passes through the detecting position D. Further, in this embodiment, during execution of the print job, the controller 200 is further capable of carrying out control on the basis of the detection signal output by the light receiving element 62 before the leading end of the image forming region of the surface of the image bearing member 10 with respect to the movement direction, where the toner image to be transferred onto the first recording material P in the print job is formable reaches the detecting position D. In other words, in this embodiment, the controller 200 is capable of executing the above-described control during execution of the print job on the basis of the detection signal output after receiving the reflected light by the light receiving element 62 when a region other than the image forming region on the surface of the image bearing member 10 on which the toner image to be transferred onto the recording material P in the print job passes through the detecting position D. Further, in other words, in this embodiment, the controller 200 is capable of carrying out control of the driving portion 90 during execution of the print job so that a time from passage, through the detecting position D, of the trailing end of the image forming region of the surface of the image bearing member 10 with respect to the movement direction, where the toner image to be transferred onto the final recording material P in the print job is formable until rotation of the image bearing member 10 is stopped in the case where a numerical value related to a detection signal output after receiving the reflected light by the light receiving element 62 after the passage, through the detecting position D, of the trailing end of the image forming region of the surface of the image bearing member 10 with respect to the movement direction, where the toner image to be transferred onto the final recording material P is formable satisfies a predetermined condition is made longer than that in the case where the numerical value related to the detection signal does not satisfy the predetermined condition.

The controller 200 carries out the control so that the numerical value related to the detection signal output after receiving the reflected light by the light receiving element 62 crosses a predetermined threshold. In this embodiment, the controller 200 can carry out the control on the basis of an average value of a numerical value related to the reflected light received by the light receiving element 62. In this embodiment, the controller 200 carries out the control in a case where an amount of the reflected light indicated by the average value is a predetermined threshold or less. However, the controller 200 can also carry out the control on the basis of the deviation of the detection signal output after receiving the reflected light by the light receiving element 62. In this case, the controller 200 can carry out the control in the case where the deviation is a predetermined threshold or more. Further, the controller 200 can also carry out the control on the basis of a change amount, relative to a first average value of a numerical value related to a detection signal output after receiving the reflected light by the light receiving element 62, of a second average value which is acquired after the first average value and which is related to a detection signal output after receiving the reflected light by the light receiving element 62, during execution of the print job. In this case, the controller 200 can carry out the control in a case where the change amount of the second average value relative to the first average value is a predetermined threshold or more. Further, the controller 200 can also change a time of the deposited matter removal processing on the basis of a speed of a fluctuation in numerical value related to a detection signal output after receiving the reflected light by the light receiving element during the print job. In this embodiment, the light receiving element 62 principally receives the specularly reflected light as the reflected light. Further, in this embodiment, the deposited matter is water deposited on the surface of the image bearing member 10. However, for detecting the water deposited on the surface of the image bearing member 10, a constitution using the light receiving element (second light receiving element) 63 for principally receiving the diffused reflection light as the reflected light may be also adopted. Further, in this embodiment, the image forming apparatus 100 includes a photosensitive member 1 which is a first image bearing member as the image bearing member and includes the intermediary transfer member 10 which is a second image bearing member for conveying a toner image, primarily transferred from the photosensitive member 1, for being secondarily transferred onto the recording material P, and the optical sensor 60 detects the reflected light by emitting light toward a surface of the intermediary transfer member 10.

Further, according to this embodiment, it becomes possible to suppress the image defect generated by the dew condensation of the surface of the intermediary transfer belt 10 or the like during the print job.

### Embodiment 2

Next, another embodiment of the present invention will be described. Basic constitution and operation of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 will be omitted from detailed description by adding thereto the same symbols as those in the embodiment 1.

In the embodiment 1, on the basis of the fluctuation in preliminarily acquired average value of the detection results by the first light receiving element 62 due to the blank rotation operation, the blank rotation operation of the intermediary transfer belt 10 was executed for 15 sec which is a preset predetermined time. On the other hand, in this embodiment, the optical sensor 60 is driven during the blank rotation operation of the intermediary transfer belt 10, and the blank rotation operation is ended on the basis of the detection result by the first light receiving element 62.

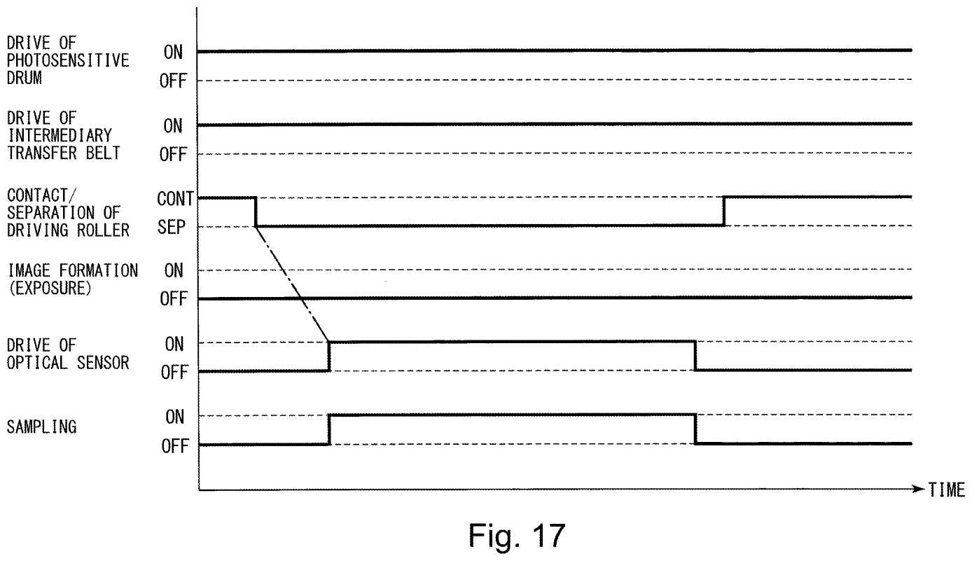

FIG. 17 is a timing chart showing an outline of an operation of the respective portions during the blank rotation operation in this embodiment. The operation in accordance with the timing chart of FIG. 17 is controlled by the DC controller 200.

In this embodiment, depending on the detection result by the first light receiving element 62, the print job is interrupted, and the developing roller 42 is separated from the photosensitive drum 1. Incidentally, the photosensitive drum 1 and the intermediary transfer belt 10 are kept rotated. The optical sensor 60 is driven by being timed to a timing when a position corresponding to a timing of the separation of the developing roller 42 from the photosensitive drum 1 reaches the optical sensor 60, and the sampling is started. This is because the amount of the reflected light from the surface of the intermediary transfer belt 10 is detected with high accuracy without being influenced by the toner moved from the developing roller 42 onto the intermediary transfer belt 10 through the photosensitive drum 1.

In this embodiment, similarly as in the embodiment 1, the DC controller 200 executes the sampling of the detection result by the first light receiving element 62 with an interval of 0.1 mm when the interval is viewed in terms of a surface movement distance of the intermediary transfer belt 10, and calculates an average value of sampling data for 100 points. That is, the DC controller 200 acquires the average value of the detection results (sampling data) of the amounts of reflected light from the surface of the intermediary transfer belt 10 during rotation of the intermediary transfer belt 10 by a distance corresponding to 10 mm. Further, in this embodiment, during the blank rotation operation, the DC controller 200 acquires the average value of the sampling data corresponding to the above-described 10 mm over 800 mm corresponding to one-full circumference of the intermediary transfer belt 10. Then, in the case where all the respective average values became higher than 3.0 V, the DC controller 200 discriminates that the dew condensation state was eliminated, and resumes the print job.

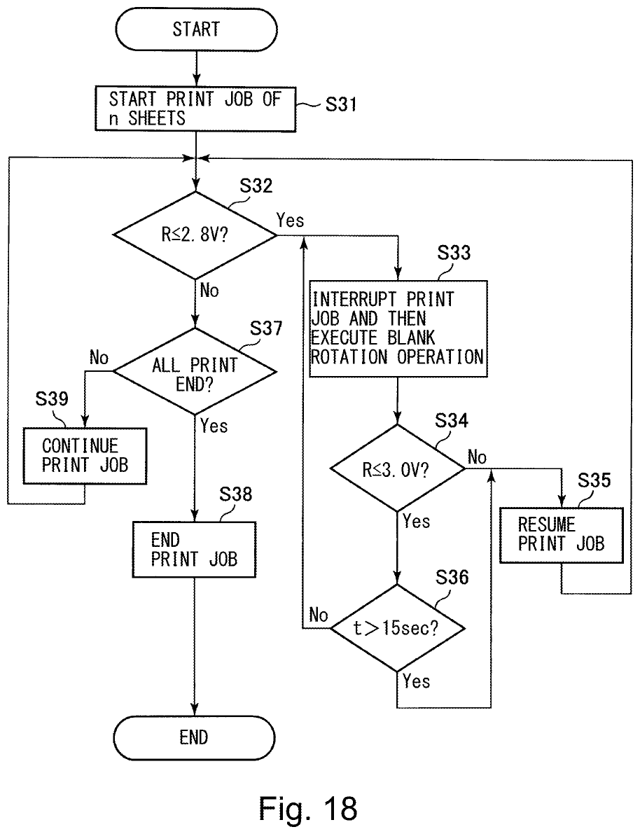

FIG. 18 is a flowchart showing an outline of an operation of the image forming apparatus 100 including a detecting operation of the dew condensation state and the dew condensation removal processing in this embodiment. The operation in accordance with the flowchart of FIG. 18 is controlled by the DC controller 200.

When a print job is instructed from the controller 210, the DC controller 200 starts the print job of n sheets (S31). Next, the DC controller 200 discriminates whether or not an average value R of the detection results by the first light receiving element 62 at a predetermined timing (sampling sections (1)~(4)) described using FIG. 7 is 2.8 V or less (S32). In the case where the DC controller 200 discriminated in S32 that the average value R of the detection result by the first light receiving element 62 is 2.8 V or less, the DC controller 200 interrupts the print job and executes the blank rotation operation (S33). Then, the DC controller 200 discriminates whether or not the average value R of the detection results by the first light receiving element 62 during the blank rotation operation is 3.0 V or less (S34). In the case where the DC controller 200 discriminated in S34 that the average value R of the detection results by the first light receiving element 62 is higher than 3.0 V, the controller 200 ends the blank rotation operation and resumes the print job (S35), and makes the discrimination of S32 again. On the other hand, in the case where the DC controller 200 discriminated in S34 that the average value R of the detection results by the first light receiving element 62 is 3.0 V or less, the DC controller 200 discriminates whether or not a time t from a start of the blank rotation operation has elapsed by a predetermined time, 15 sec in this embodiment (S36). Then, in the case where the DC controller 200 discriminated in S36 that the time t does not elapse by 15 sec, the DC controller 200 executes the blank rotation operation continuously (S33). Further, in the case where the DC controller 200 discriminated in S36 that the time t has elapsed by 15 sec, the DC controller 200 ends the blank rotation operation, and resumes the print job (S35), and makes the discrimination of S32 again. By this, even in the case where the above-described average value R does not become 3.0 V or less by an change in state of the intermediary transfer belt 10 due to a factor other than the water (moisture), the blank rotation operation can be ended as a result that the water on the surface of the intermediary transfer belt 10 was capable of being removed sufficiently. Further, in the case where the DC controller 200 discriminated in S32 that the average value R of the detection result by the first light receiving element 62 is larger than 2.8 V, the DC controller 200 discriminates whether or not all the prints of the print job are ended (S37). In the case where the DC controller 200 discriminated in S37 that all the prints of the print job is ended, the DC controller 200 ends the print job (S38). On the other hand, in the case where the DC controller 200 discriminated in S37 that all the prints of the print job are not ended, the DC controller 200 continues the print job (S39), and makes the discrimination of S32 again.

Incidentally, the average value used in S34 is an AV of the sampling data acquired corresponding to 100 points with an interval of 0.1 mm in terms of the surface movement distance of the intermediary transfer belt 10, and it may only be required that the average value for every 100 points is monitored and whether or not the monitored average value is 3.0 V or less is discriminated. Further, a moving average of the first light receiving element 62 during the blank rotation operation may also be used.

Further, in this embodiment, the print job is resumed by, as a trigger, that the average value of the detection results by the first light receiving element 62 became higher than 3.0 V over one-full circumference of the intermediary transfer belt 10, but the trigger for resumption of the print job is not limited to this. For example, it is not necessarily required to employ, as the trigger, that the detection result by the first light receiving element 62 exceeds a predetermined value over one-full circumference of the intermediary transfer belt 10, the trigger may only be required to be appropriately be set in view of a remaining number of prints in the print job, and sensitivity of the occurrence of the image defect, an allowable range of an image quality, and the like in the image forming apparatus 100. In the case where the surface state is sufficiently restored from the dew condensation state in at least a part of a region of the intermediary transfer belt 10 with respect to the rotational direction of the intermediary transfer belt 10, the print job can be resumed.

Further, also, in this embodiment, changes similar to those in the modified embodiments described in the embodiment 1 can be appropriately made. For example, the blank rotation operation is executed when the print job is ended, and in addition, the blank rotation operation can be ended on the basis of the detection result by the first light receiving element 62 during the blank rotation operation.

Thus, in this embodiment, the controller 200 carries out control of the driving portion 90 so as to end the blank rotation operation on the basis of the detection signal output after receiving the reflected light by the first light receiving element 62 during execution of the blank rotation operation.

As described above, in this embodiment, by performing the operation as described above, the water droplets on the surface of the intermediary transfer belt 10 can be removed more reliably in the dew condensation removal processing. Further, in the case where the dew condensation was capable of being removed early, the blank rotation operation is ended quickly, so that down time can be shortened. For that reason, according to this embodiment, it is possible to suppress the occurrence of the image defect with the dew condensation more efficiently and more reliably.

### Embodiment 3

Next, another embodiment of the present invention will be described. Basic constitution and operation of an image forming apparatus of this embodiment are the same as those of the image forming apparatus of the embodiment 1. Accordingly, in the image forming apparatus of this embodiment, elements having identical or corresponding functions or constitutions to those of the image forming apparatus of the embodiment 1 will be omitted from detailed description by adding thereto the same symbols as those in the embodiment 1.

In the embodiments 1 and 2, the case where detection of the water droplets due to the dew condensation on the intermediary transfer belt 10 is made by the optical sensor 60 was described, but by the optical sensor 60, it is also possible to perform the detection of a substance other than the water droplets. For example, in the case where a foreign matter such as sand enters the inside of the image forming apparatus 100 during the print job and is gradually deposited on the intermediary transfer belt 10 or the like, it is possible to detect this by the optical sensor 60. In this embodiment, detection of the sand on the intermediary transfer belt 10 will be described.

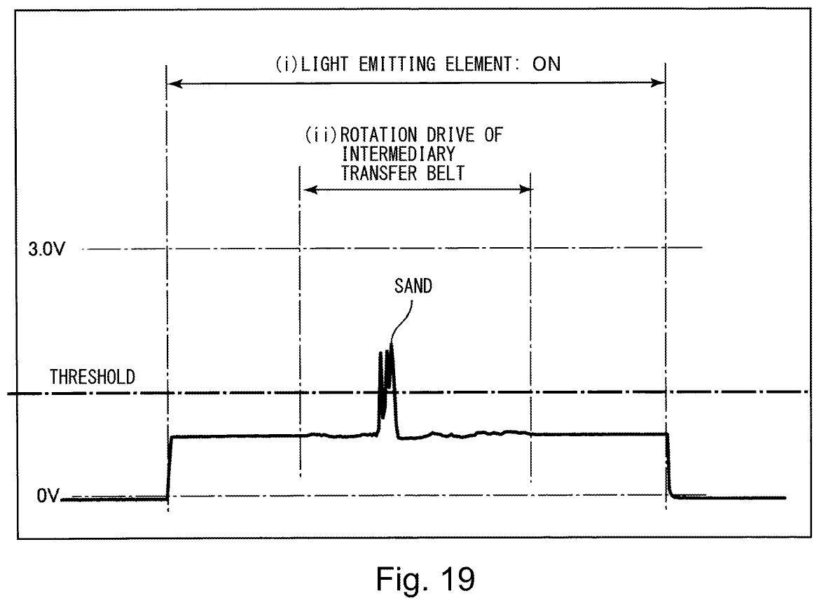

FIG. 19 is a graph showing a detection waveform by the second light receiving element 63 when the sand passed through a position of the optical sensor 60 in the case where the sand exists on the intermediary transfer belt 10. In a section (i) in FIG. 19, the light emitting element 61 is driven. As shown in FIG. 19, the reflected light from the surface of the intermediary transfer belt is principally the specularly reflected light, and therefore, a light reception amount of the second light receiving element 63 receiving the diffused reflection light is small. On the other hand, the reflected light from the sand is principally the diffused reflection light, and therefore, the light reception amount of the second light receiving element 63 becomes large at a timing when the sand passes through the detecting position D of the optical sensor 60. By utilizing this tendency, for example, as shown in FIG. 19, as the case where a predetermined condition is satisfied, a threshold is set in advance, and in the case where a detection signal (detection output) such that the detection signal exceeds (crosses) the threshold is acquired, it is possible to discriminate that the foreign matter such as the sand exists on the intermediary transfer belt 10 (abnormality on the intermediary transfer belt 10).

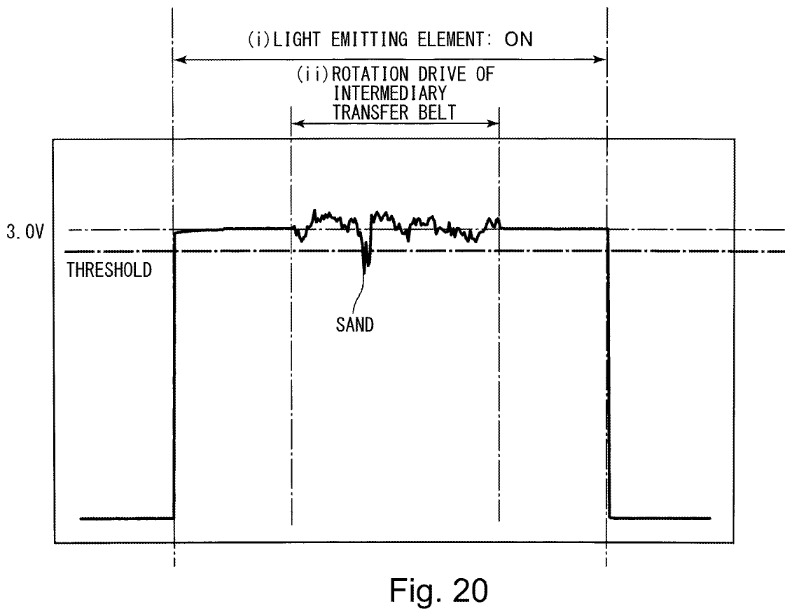

Further, the diffused reflection light can also be received by the first light receiving element 62. FIG. 20 is a detection waveform in the case where sand on the intermediary transfer belt 10, which is the same as the sand in the case of FIG. 19 was detected by the first light receiving element 62. At a timing when the sand passes through the detecting position D of the optical sensor 60, the light reception amount of the light detected by the first light receiving element 62 lowers correspondingly a lowering in amount of the specularly reflected light from the surface of the intermediary transfer belt 10. By utilizing this tendency, for example, as shown in FIG. 19, a threshold is set in advance as the case where a predetermined condition is satisfied, and in the case where a detection signal (detection output) such that the detection signal exceeds (crosses) the threshold is acquired, it is possible to discriminate that the foreign matter such as the sand exists on the intermediary transfer belt 10 (abnormality on the intermediary transfer belt 10).

In the case where the foreign matter on the intermediary transfer belt 10 was detected as described above, the DC controller 200 is capable of carrying out control so as to execute notifying processing for notifying an operator such as a user of that effect in at least one of the operating portion 150 and the external device 300. Specifically, in the case where the foreign matter on the intermediary transfer belt 10 is detected, the DC controller 200 carries out control so as to output, to the operating portion 150 or the external device 300, a signal for notifying the operator such as the user of information on deposition of the foreign matter onto the surface of the intermediary transfer belt 10. The information notified by the notifying processing may be contents simply notifying the presence of the foreign matter on the intermediary transfer belt 10 or may also be contents prompting the user to perform maintenance (cleaning or the like) or exchange of the intermediary transfer belt 10. Further, the DC controller 200 is capable of carrying out control so as to execute the notifying processing, and in addition, to stop (prohibit) the operation (printing) of the image forming apparatus 100 until predetermined processing (cleaning or exchange) is performed by the operator such as the user. Then, the DC controller 200 is capable of carrying out control so as to be capable of resuming the operation (printing) of the image forming apparatus 100 in the case where the predetermined information is input by the operation by the operator such as the user from at least one of the operating portion 150 and the external device 300 or in the case where exchange is detected by a mechanism for detecting that the intermediary transfer belt 10 or a unit including this was exchanged.

Further, in the case where the foreign matter on the intermediary transfer belt was detected as described above, as restoration processing from the abnormality on the intermediary transfer belt 10, the DC controller 200 may also carry out control so as to execute foreign matter removal processing for removing the foreign matter on the intermediary transfer belt 10. The foreign matter removal processing is an example of the deposited matter removal processing for removing the deposited matter (sand or the like in this embodiment) on the surface of the intermediary transfer belt 10. The foreign matter removal processing is executed, for example, after interrupting the print job, on the basis of the detection result by the optical sensor 60 during the print job. Or, the foreign matter removal processing may also be executed when the print job is ended, on the basis of the detection result by the optical sensor 60 during the print job. As the foreign matter removal processing, a blank rotation operation similar to the blank rotation operations in the embodiments 1 and 2 can be exemplified. By this, the foreign matter on the intermediary transfer belt 10 can be removed by the electroconductive brush 16 (FIG. 1) and the belt cleaning device (FIG. 16). The blank rotation operation as the foreign matter removal processing can be executed over a predetermined time (for example, 15 sec) set in advance similarly as the blank rotation operation in the embodiment 1. Or, the blank rotation operation as the foreign matter removal processing can be ended in the case where discrimination that the foreign matter was removed is made on the basis of the detection result by the optical sensor 60 similarly as in the embodiment 2. In this case, in the case where the detection result by the second light receiving element 63 did not become more than the predetermined threshold (or the detection result by the first light receiving element 62 did not become below the predetermined threshold), the blank rotation operation as the foreign matter removal processing can be ended.

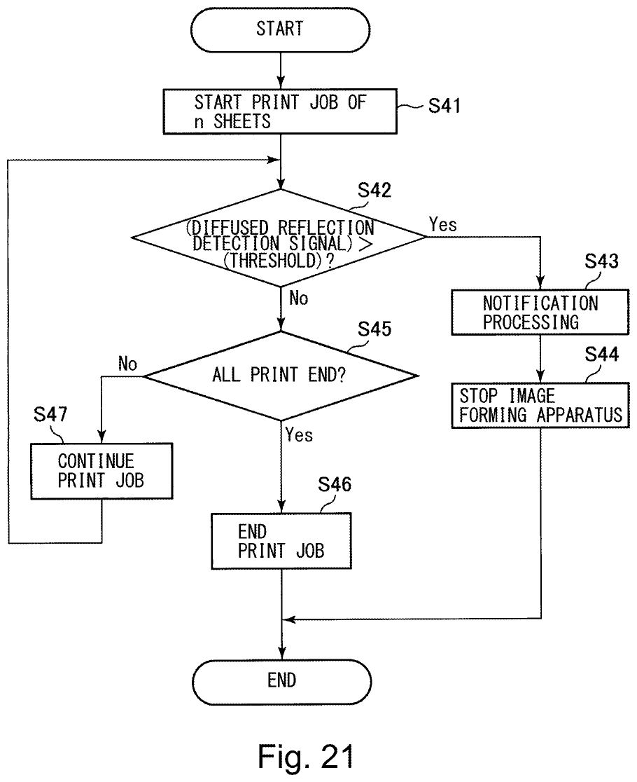

FIG. 21 is a flowchart showing an outline of an operation of the image forming apparatus 100 including a detecting operation of the foreign matter on the intermediary transfer belt 10 and the notifying processing in this embodiment. The operation in accordance with the flowchart of FIG. 21 is controlled by the DC controller 200.

When a print job is instructed from the controller 210, the DC controller 200 starts the print job of n sheets (S41). Next, the DC controller 200 discriminates whether or not the detection result by the second light receiving element 63 at a predetermined timing (sampling sections (1)~(4)) described using FIG. 7 exceeded the predetermined threshold (S42). In the case where the DC controller 200 discriminated in S42 that the detection result by the second light receiving element 62 exceeded the predetermined threshold, the DC controller 200 interrupts the print job and executes the notifying processing in the operating portion 150 or the external device 300 (S43), so that the operation of the image forming apparatus 100 is stopped (S44). On the other hand, in the case where the DC controller 200 discriminated in S42 that the detection result by the second light receiving element 63 is the predetermined threshold or less, the DC controller 200 discriminates whether or not all the prints of the print job are ended (S45). In the case where the DC controller 200 discriminated in S45 that all the prints of the print job is ended, the DC controller 200 ends the print job (S46). On the other hand, in the case where the DC controller 200 discriminated in S45 that all the prints of the print job are not ended, the DC controller 200 continues the print job (S47), and makes the discrimination of S42 again.

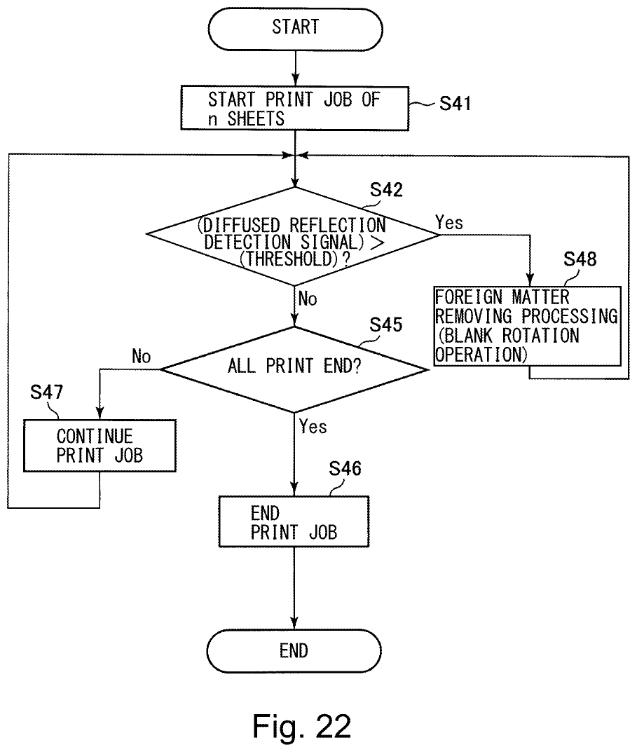

FIG. 22 is a flowchart showing an outline of an operation of the image forming apparatus 100, including the detecting operation of the foreign matter on the intermediary transfer belt 10 and the foreign matter removal processing in this embodiment. The operation in accordance with the flowchart of FIG. 22 is controlled by the DC controller 200. Here, the case where the print job is interrupted and then the foreign matter removal processing is executed is taken as an example.

In the flowchart of FIG. 22 and the flowchart of FIG. 21, processes S41, S42, and S45 are the same, so that description thereof will be omitted. In this example, in the case where the DC controller 200 discriminated in S42 that the detection result by the second light receiving element 63 exceeded the predetermined threshold, the print job is interrupted and then the blank rotation operation as the foreign matter removal (removing) processing is executed (S48). After the blank rotation operation as the foreign matter removal processing is ended, the DC controller 200 resumes the print job, and makes the discrimination of S42 again.

Incidentally, as described above, the DC controller 200 discriminates in S42 whether or not the detection result by the second light receiving element 63 is below the predetermined threshold and may execute the notifying processing and the foreign matter removal processing in the case where the detection result is below the predetermined threshold. Further, as described above, the foreign matter removal processing may also be executed when the print job is ended. Further, the foreign matter is not limited to the sand, but may also be an arbitrary deposited matter such as toner which is not originally present in a region (non-image forming region) other than the image forming region.

As described above, in the case where the foreign matter such as the sand or the toner is deposited, by comparing the detection result by the first light receiving element 62 or the second light receiving element 63 with the threshold set in advance, it is possible to discriminate the abnormality on the surface of the intermediary transfer belt 10. Thus, by making the discrimination based on the set threshold, it is possible to detect occurrence of the image defect which is hard to be suppressed only by detecting the deposition of the water droplets or to detect a sign of damage of the intermediary transfer belt 10 or members contacting the intermediary transfer belt 10.

As regards the detection of the dew condensation state described in the embodiments 1 and 2 and the detection of the foreign matter described in this embodiment, both can be executed in parallel. For example, in addition to the average value of the detection results by the first light receiving element 62 and a change amount thereof, discrimination by the threshold of the detection result by the second light receiving element 63 is made, and in the case where either one thereof satisfies the predetermined condition described above, it is possible to discriminate that there is normality on the intermediary transfer belt 10. By this, it becomes possible to prevent the occurrence of the image defect.

Thus, in this embodiment, the light receiving element 63 receives the diffuse reflection light as the reflected light. Further, in this embodiment, in the case where a numerical value related to the detection signal output by reception of the reflected light by the light receiving element 63 exceeds a threshold, the controller 200 is capable of carrying out control so as to execute the deposited matter removal processing (foreign matter removal processing) or the notifying processing. However, the light receiving element 62 may also receive principally the specularly reflected light as the reflected light. Further, in this case, in the case where the light reception amount indicated by the detection signal output by reception of the reflected light by the light receiving element 62 is below the predetermined threshold, the controller 200 is capable of carrying out control so as to execute the deposited matter removal processing (foreign matter removal processing) or the notifying processing. In this embodiment, the image forming apparatus 100 includes a photosensitive member 1 which is a first image bearing member as the image bearing member and includes the intermediary transfer member 10 which is a second image bearing member for conveying a toner image, primarily transferred from the photosensitive member 1, for being secondarily transferred onto the recording material P, and the optical sensor 60 detects the reflected light by emitting light toward a surface of the intermediary transfer member 10.

As described above, according to this embodiment, it becomes possible to suppress the image defect generated by the deposition of the foreign matter such as the sand onto the surface of the intermediary transfer belt 10 or the like during the print job.

### Other Embodiments

Hereinabove, the present invention was described based on specific embodiments, but the present invention is not limited to the above-described embodiments.

In the above-described embodiments, the dew condensation state or the deposition of the foreign matter was detected by detection of the reflected light from the surface of the intermediary transfer belt which is the image bearing member (second image bearing member) by the optical sensor, but the present invention is not limited to such an example. The dew condensation state or the deposition of the foreign matter may also be detected by detection of the reflected light from the surface of the photosensitive drum which is the image bearing member (first image bearing member) by the optical sensor. In addition, both detections of these may also be performed.

Further, in the above-described embodiments, the image forming apparatus was the image forming apparatus capable of forming a full-color image, but the present invention is not limited to such an example. The present invention is also applicable to an image forming apparatus capable of forming only a monochromatic (white/black or monocolor) image.

Further, the photosensitive member is not limited to a drum-like one (photosensitive drum), but may also be, for example, an endless belt-like one (photosensitive belt). Further, the intermediary transfer member is not limited to an endless belt, but may also be, for example, an intermediary transfer drum shaped in a drum by being stretched and provided to a frame.

Further, in the above-described embodiments, the developing member performed development in contact with the photosensitive member, but may also perform the development in a state in which the developing member is disposed opposed to the photosensitive member in non-contact with the photosensitive member.

Further, in the above-described embodiments, the image forming apparatus included the cleaning device for cleaning the surface of the photosensitive member, but may also have a constitution in which the image forming apparatus does not include a particular cleaning device for cleaning the surface of the photosensitive member. In this case, transfer residual toner on the photosensitive member may also be collected by the developing device.

Further, in the above-described embodiments, as an example, the operation in the case where the font-side optical sensor 60F was used was described. However, the present invention is not limited to this, but may also use the rear-side optical sensor 60R. Further, both the front-side optical sensor 60F and the rear-side optical sensor 60R may also be used. In this case, for example, in the case where the dew condensation state was detected by either one of the optical sensors 60 or in the case where the dew condensation state was detected by both the optical sensors 60, the restoration processing is capable of being executed. The same applies to also the detection of the foreign matter such as the sand. Further, the number of the optical sensors capable of detecting the reflected light from the surface of the image bearing member provided to the image forming apparatus is not limited to two, but may also be one, or three or more.

### INDUSTRIAL APPLICABILITY

According to the present invention, there is provided the image forming apparatus for forming the image on the recording material by using the electrophotographic process or electrostatic recording process.

The present invention is not limited to the above-described embodiments, but can be variously changed and modified without departing from the spirit and the scope of the present invention. Accordingly, the following claims are attached for making the scope of the present invention public.

The present application claims priority on the basis of Japanese Patent Application Nos. 2023-159284 filed on Sep. 22, 2023, which is hereby incorporated by reference herein in its entirety.

1. An image forming apparatus for executing a print job in which a print image is formed on a single or a plurality of recording materials by one start instruction and the single or the plurality of recording materials are discharged from an inside to an outside of the image forming apparatus through a recording material discharge opening, the image forming apparatus comprising:
toner image forming means for forming a toner image;
a rotatable image bearing member for bearing the toner image, on a surface thereof, formed by the toner image forming means;
transfer means for transferring the toner image, onto the recording material, formed on the surface of the image bearing member; and
an optical sensor which includes a light emitting element for emitting light toward the surface of the image bearing member and a light receiving element for receiving reflected light reflected after emission of the light from the light emitting element toward the surface of the image bearing member and for outputting a detection signal depending on a light reception amount and which is for detecting the reflected light in a detecting position in a movement direction of the surface of the image bearing member,
wherein the image forming apparatus comprises a controller capable of carrying out control so as to execute deposition matter removal processing for removing a deposited matter on the surface of the image bearing member during execution of the print job on the basis of the detection signal output after receiving the reflected light by the light receiving element in a period from passage, through the detecting position, of a trailing end of an image forming region of the surface of the image bearing member with respect to the movement direction, where the toner image to be transferred onto a preceding recording material is formable until a leading end of an image forming region of the surface of the image bearing member with respect to the movement direction, where the toner image to be transferred onto a subsequent recording material is formable reaches the detecting position.

2. The image forming apparatus according to claim 1, wherein the controller carries out control of a driving portion for rotationally driving the image bearing member so that as the deposited matter removal processing, a blank rotation operation for rotating the image bearing member without forming the toner image on the surface of the image bearing member is executed.

3. The image forming apparatus according to claim 2, wherein the controller carries out the control of the driving portion so as to execute the blank rotation operation over a predetermined time.

4. The image forming apparatus according to claim 2, wherein the controller carries out the control of the driving portion so as to end the blank rotation operation on the basis of a detection signal output after receiving the reflected light by the light receiving element during execution of the blank rotation operation.

5. The image forming apparatus according to claim 1, wherein the controller carries out control of a driving portion for rotationally driving the image bearing member so that as the deposited matter removal processing, rotation of the image bearing member is maintained in a stopped state for a predetermined time.

6. The image forming apparatus according to claim 1, wherein the controller executes the deposited matter removal processing after interrupting formation of the toner image on the surface of the image bearing member in the print job.

7. The image forming apparatus according to claim 1, wherein the controller executes the deposited matter removal processing after formation of all of toner images on the surface of the image bearing members in the print job is ended.

8. The image forming apparatus according to claim 1, wherein during execution of the print job, the controller is further capable of carrying out the control on the basis of a detection signal output after receiving the reflected light by the light receiving element after a trailing end of an image forming region of the surface of the image bearing member with respect to the movement direction, where the toner image to be transferred onto a final recording material in the print job is formable passes through the detecting position.

9. The image forming apparatus according to claim 1, wherein during execution of the print job, the controller is further capable of carrying out control on the basis of a detection signal output by the light receiving element before a leading end of an image forming region of the surface of the image bearing member with respect to the movement direction, where the toner image to be transferred onto a first recording material in the print job is formable reaches the detecting position.

10. An image forming apparatus for executing a print job in which a print image is formed on a single or a plurality of recording materials by one start instruction and the single or the plurality of recording materials are discharged from an inside to an outside of the image forming apparatus through a recording material discharge opening, the image forming apparatus comprising:
toner image forming means for forming a toner image;
a rotatable image bearing member for bearing the toner image, on a surface thereof, formed by the toner image forming means;
a driving portion for rotationally driving the image bearing member;
transfer means for transferring the toner image, onto the recording material, formed on the surface of the image bearing member; and
an optical sensor which includes a light emitting element for emitting light toward the surface of the image bearing member and a light receiving element for receiving reflected light reflected after emission of the light from the light emitting element toward the surface of the image bearing member and for outputting a detection signal depending on a light reception amount and which is for detecting the reflected light in a detecting position in a movement direction of the surface of the image bearing member,
wherein the image forming apparatus comprises a controller capable of carrying out control of the driving portion during execution of the print job so that a time from passage, through the detecting position, of a trailing end of an image forming region of the surface of the image bearing member with respect to the movement direction, where the toner image to be transferred onto a final recording material in the print job is formable until rotation of the image bearing member is stopped in a case where a numerical value related to a detection signal output after receiving the reflected light by the light receiving element after the passage, through the detecting position, of the trailing end of the image forming region of the surface of the image bearing member with respect to the movement direction, where the toner image to be transferred onto the final recording material is formable satisfies a predetermined condition is made longer than that in a case where the numerical value related to the detection signal does not satisfy the predetermined condition.

11. The image forming apparatus according to claim 1, wherein the controller carries out the control in a case where a numerical value related to the detection signal output after receiving the reflected light by the light receiving element crosses a predetermined threshold.

12. The image forming apparatus according to claim 1, wherein the controller carries out the control on the basis of an average value of a numerical value related to the detection signal output after receiving the reflected light by the light receiving element.

13. The image forming apparatus according to claim 12, wherein the controller carries out the control in a case where an amount of the reflected light indicated by the average value is a predetermined threshold or less.

14. The image forming apparatus according to claim 1, wherein the controller carries out the control on the basis of a deviation of a detection signal output after receiving the reflected light by the light receiving element.

15. The image forming apparatus according to claim 14, wherein the controller carries out the control in a case where the deviation is a predetermined threshold or more.

16. The image forming apparatus according to claim 1, wherein the controller carries out the control on the basis of a change amount, to a first average value of a numerical value related to a detection signal output after receiving the reflected light by the light receiving element, of a second average value which is acquired after the first average value and which is related to a detection signal output after receiving the reflected light by the light receiving element, during execution of the print job.

17. The image forming apparatus according to claim 16, wherein the controller carries out the control in a case where the change amount of the second average value to the first average value is a predetermined threshold or more.

18. The image forming apparatus according to claim 1, wherein the controller changes a time of the deposited matter removal processing on the basis of a speed of a fluctuation in numerical value related to a detection signal output after receiving the reflected light by the light receiving element during the print job.

19. The image forming apparatus according to claim 1, wherein the light receiving element principally receives specularly reflected light as the reflected light.

20. The image forming apparatus according to claim 19, wherein the deposited matter is water deposited on the surface of the image bearing member.

21. The image forming apparatus according to claim 1, wherein the light receiving element principally receives diffused reflection light as the reflected light.

22. The image forming apparatus according to claim 21, wherein the deposited matter is sand deposited on the surface of the image bearing member.

23. The image forming apparatus according to claim 1, wherein the image forming apparatus includes a photosensitive member which is a first image bearing member as the image bearing member and includes an intermediary transfer member which is a second image bearing member for conveying a toner image, primarily transferred from the photosensitive member, for being secondarily transferred onto the recording material, and
wherein the optical sensor detects the reflected light by emitting light toward a surface of the intermediary transfer member.
